(19) United States
(12) Patent Application Publication
(10) Pub. No.: US 2017/0148176 A1
(43) Pub. Date: May 25, 2017

(54) NON-TRANSITORY COMPUTER-READABLE STORAGE MEDIUM, EVALUATION METHOD, AND EVALUATION DEVICE

(71) Applicant: FUJITSU LIMITED, Kawasaki-shi (JP)

(72) Inventors: Miho Sakai, Yokohama (JP); Atsushi Oguchi, Kawasaki (JP)

(73) Assignee: FUJITSU LIMITED, Kawasaki-shi (JP)

(21) Appl. No.: 15/344,192

(22) Filed: Nov. 4, 2016

(30) Foreign Application Priority Data
Nov. 24, 2015 (JP) 2015-228982

(51) Int. Cl. G06T 7/223; G06T 11/60; A63F 13/816; A63F 13/213; A63F 13/428; H04N 5/232; G06K 9/00

(52) U.S. Cl. CPC G06T 7/223; H04N 5/23293; G06T 11/60; G06K 9/00342; A63F 13/213; A63F 13/428; A63F 13/816; G06T 2207/20021; G06T 2207/20221; G06T 2207/30196; A63F 2300/8005; A63F 2300/1093

(57) ABSTRACT

A non-transitory computer-readable storage medium storing an evaluation program that causes a computer to execute a process, the process comprising obtaining a captured image captured by an imaging device, displaying the plurality captured images on a display device and displaying a display that indicates a separation between a plurality of set areas set in the captured image while superimposing on the captured image, and detecting timings at which each of a plurality of persons beat rhythm by analyzing the captured images, each of the plurality of persons being included in each of the plurality of set areas.

### CROSS-REFERENCE TO RELATED APPLICATION

This application is based upon and claims the benefit of priority of the prior Japanese Patent Application No. 2015-228982, filed on Nov. 24, 2015, the entire contents of which are incorporated herein by reference.

### FIELD

The embodiments discussed herein are related to, a non-transitory computer-readable storage medium, an evaluation method, and an evaluation device.

### BACKGROUND

Technologies are known for scoring a dance of a person and notifying the person of a scoring result. As an example of a technology related to scoring and evaluating a dance of a person, there is a technology related to a game in which a part of a person's body is moved to a song. In the technology, in cases in which a part of a body of a player performing the game has moved at a speed greater than or equal to a reference speed, a game play of the player is evaluated based on a determination as to whether or not a substantially motionless state of the body part is maintained for a reference period.

Related technologies are disclosed in Japanese Laid-open Patent Publication No. 7-50825, Japanese Laid-open Patent Publication No. 2000-237455, and Japanese Laid-open Patent Publication No. 2013-154125.

### SUMMARY

According to an aspect of the invention, a non-transitory computer-readable storage medium storing an evaluation program that causes a computer to execute a process, the process comprising obtaining a captured image captured by an imaging device, displaying the plurality captured images on a display device and displaying a display that indicates a separation between a plurality of set areas set in the captured image while superimposing on the captured image, and detecting timings at which each of a plurality of persons beat rhythm by analyzing the captured images, each of the plurality of persons being included in each of the plurality of set areas.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an evaluation device according to a first embodiment;

FIG. 2 is a diagram illustrating an example of a frame;

FIG. 3 is a diagram illustrating an example of timing data;

FIG. 4 is a diagram illustrating an example of a number-of-persons selection screen according to the first embodiment;

FIG. 5 is a diagram illustrating examples of evaluation target areas according to the first embodiment;

FIG. 6 is a diagram illustrating an example of number-of-persons determination processing using a facial recognition technology according to the first embodiment;

FIG. 7 is a diagram illustrating an example of number-of-persons determination processing using an object recognition technology according to the first embodiment;

FIG. 8 is a diagram illustrating an example of an area partitioning display according to the first embodiment;

FIG. 9 is a diagram illustrating another example of the area partitioning display according to the first embodiment;

FIG. 10 is a diagram illustrating an example of a binarized image;

FIG. 11 is a diagram illustrating an example of setting background difference amount, evaluation target area, and a frame number associated each other;

FIG. 12 is a diagram for explaining an example of processing performed by the evaluation device according to the first embodiment;

FIG. 13 is a diagram illustrating an example of a graph plotting timings at which a person beat time indicated by the timing data;

FIG. 14 is a diagram illustrating an example of a method for comparing timings;

FIG. 15 is a diagram illustrating an example of an evaluation display screen;

FIG. 16 is a diagram illustrating another example of the evaluation display screen;

FIG. 17 is a diagram illustrating an example of a result display screen according to the first embodiment;

FIG. 18 is a flowchart illustrating an example of processing according to the first embodiment;

FIG. 19 is a flowchart illustrating an example of evaluation processing according to the first embodiment;

FIG. 20 is a diagram illustrating an example of a visual effect according to a second embodiment;

FIG. 21 is a diagram illustrating an example of a visual effect in which each part of a graphic is displayed according to the second embodiment;

FIG. 22 is a diagram illustrating another example of the visual effect in which each part of a graphic is displayed according to the second embodiment;

FIG. 23 is a diagram illustrating an example of a visual effect for displaying characters according to the second embodiment;

FIG. 24 is a diagram illustrating an example of a warning to a person crossing the partitioning line according to a third embodiment;

FIG. 25 is a diagram illustrating an example of a warning in cases in which players get too close to each other according to the third embodiment;

FIG. 26 is a diagram illustrating an example of synchronization determination processing according to a fourth embodiment;

FIG. 27 is a diagram illustrating an example of a system in cases in which an evaluation device and a karaoke device operate in synchronization with each other;

FIG. 28 is a diagram illustrating an example of a system including a server; and

FIG. 29 is a diagram illustrating a computer to execute an evaluation program.

### DESCRIPTION OF EMBODIMENTS

Note that, a case in which a dance performed by plural persons is evaluated is conceivable. However, a proper evaluation may be obstructed when an evaluation of a dance performed by plural persons is attempted based on movements of body parts of players. For example, if plural persons dance at the same time in an imaging area, evaluation is liable to be affected by a motion of a person with a large build and a motion of a person close to an imaging device. Furthermore, positions of respective persons may overlap with each other within the imaging area, thereby obstructing dance by each person to be properly evaluated. Thus, in order to properly evaluate a dance performed by each person, it is desirable that a separate area is provided within an imaging area in which each person performs a dance.

In one aspect, an object is to provide an evaluation program, an evaluation method, and an evaluation device capable of letting each person recognize a target area in which an evaluation of a dance is performed.

Hereinafter, embodiments of an evaluation program, an evaluation method, and an evaluation device, disclosed in the present application, will be described in detail, based on drawings. Note that the disclosed technology is not limited by the present embodiments. In addition, individual embodiments illustrated as follows may be combined as appropriate to the extent no inconsistency arises.

### First Embodiment

### Example of Functional Configuration of Evaluation Device 10 According to First Embodiment

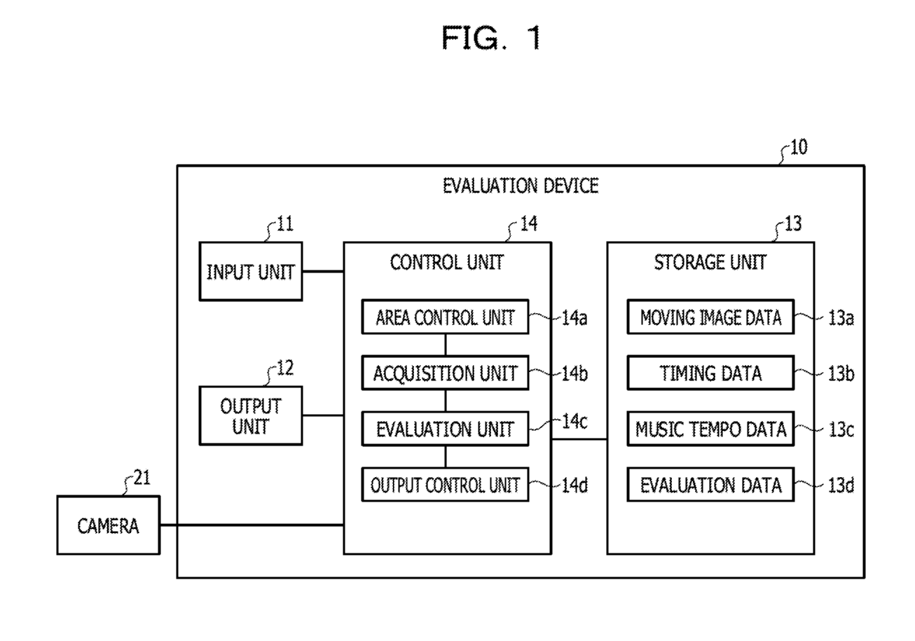

An evaluation device 10 illustrated in an example of FIG. 1 is installed in, for example, a karaoke box or the like and analyzes a motion of a player, image-captured by a camera 21. The evaluation device 10 operates in synchronization with, for example, a karaoke device provided in the karaoke box, evaluates the analyzed motion of the player, and causes to display an evaluation result in real time. The evaluation device 10 evaluates the motion of the player, for example, according to the degree to which the motion of the player matches a reference tempo obtained from a sound source of the karaoke device. A system configuration of the karaoke box including the evaluation device 10 will be described in detail later.

The evaluation device 10 illustrated in the example of FIG. 1 analyzes a motion of a person, based on each frame of moving image obtained as a result of image-capturing a dancing person using the camera 21, for each of the divided imaging areas (hereinafter, sometimes referred to as “evaluation target areas”). Specifically, the evaluation device 10 extracts a timing at which a motion amount of a person temporarily decreases, as timing at which the person keeps rhythm, in other words, a timing at which the person beats time.

The reason for extracting a timing at which a motion amount of a person temporarily decreases as the timing at which the person beats time is because a person temporarily stops a motion when beating time, thereby causing the motion amount to be temporarily decreased. Here, the term “rhythm” means, for example, regularity of tempo. The term “tempo” means, for example, an interval between beats. Next, the evaluation device 10 compares the tempo indicated by the extracted timing and the reference tempo that is the tempo serving as a reference, so as to evaluate the tempo of a person's motion. The evaluation device 10 thereby extracts a timing at which a person beats time and evaluates a tempo of a motion of the person, without performing recognition processing for recognizing a human face, parts of human body, or instruments, namely, recognition processing with high processing volume (with high processing load). Accordingly, the evaluation device 10 enables a tempo of a person's motion to be evaluated in a simple manner.

In the present embodiment, the evaluation device 10 extracts timing at which a person beats time, in each of plurally divided evaluation target areas, which has been divided by an area control unit 14a, described later. In addition, the evaluation device 10 causes partitioning into divided evaluation target areas to be displayed superimposed on a captured image display. In this manner, according to the present embodiment, motions of each person in each plural area set as the imaging areas are analyzed, and an indication of separation into each divided area is displayed superimposed on the display device. This, accordingly, enables each person to recognize target areas for the evaluation of a dance.

FIG. 1 is a block diagram illustrating an example of a configuration of an evaluation device according to a first embodiment. As illustrated in the example of FIG. 1, the evaluation device 10 includes an input unit 11, an output unit 12, a storage unit 13, and a control unit 14.

The input unit 11 inputs various kinds of information to the control unit 14. For example, when the input unit 11 receives an instruction to perform evaluation processing, described later, from a user who uses the evaluation device 10, the input unit 11 inputs the received instruction to the control unit 14. Examples of devices for the input unit 11 may include a mouse, a keyboard, and a network card used for receiving various kinds of information transmitted by other devices, not illustrated, and entering the received information to the control unit 14.

The output unit 12 outputs various kinds of information. For example, when the output unit 12 receives an evaluation result of a tempo of a motion of a person from an output control unit 14d, described later, the output unit 12 displays the received evaluation result or transmits the received evaluation result to a mobile terminal maintained by the user or an external monitor. Examples of devices for the output unit 12 may include a monitor, a network card used for transmitting various information transmitted from the control unit 14 to other non-illustrated devices, and the like.

The storage unit 13 stores various kinds of information. The storage unit 13 stores, for example, moving image data 13a, timing data 13b, music tempo data 13c, and evaluation data 13d.

The moving image data 13a is moving image data containing plural frames obtained as a result of image-capturing plural dancing persons, using the camera 21. Examples of such plural persons may include persons who sing to a song played by a karaoke device in a karaoke box and at the same time dance to the played song. Note that the plural frames contained in the moving image data 13a are obtained by a continuous image-capturing with the camera 21, which is an example of a captured image.

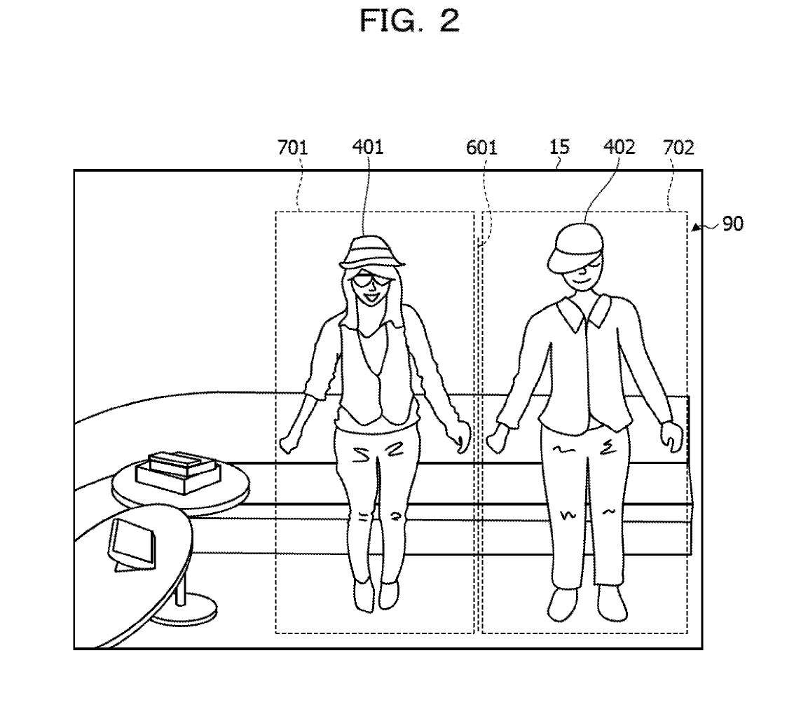

FIG. 2 is a diagram illustrating an example of a frame. The example of FIG. 2 illustrates a case in which a frame 15 includes persons 401 and 402 who sing to a song and at the same time dance to the song in a karaoke box 90. Hereinafter, the person 401 and the person 402 are also referred to as a player A and a player B, respectively. When the persons are collectively referred to without distinction, the persons are also referred to as players.

In addition, the frame 15 is divided by a dividing line 601 into a left side evaluation target area 701 (hereinafter, also referred to as an “area A”) and a right side evaluation target area 702 (hereinafter, also referred to as an “area B”). The dividing line 601 is an example of a dividing line. The player A 401 is positioned in the left side evaluation target area 701, and the player B 402 is positioned in the right side evaluation target area 702, out of the divided imaging areas. Note that while any given value may be employed as the frame rate of the moving image data 13a, the frame rate of 30 fps (frames per second) is used in the following explanation.

The timing data 13b is data that indicates time (timing) at which a player who dances beats time. For example, when a player in the moving image data 13a sings and dances to a played song in a karaoke box, the dance is started as the song begins. Thus, time from the start of a song and a dance is an example of such data.

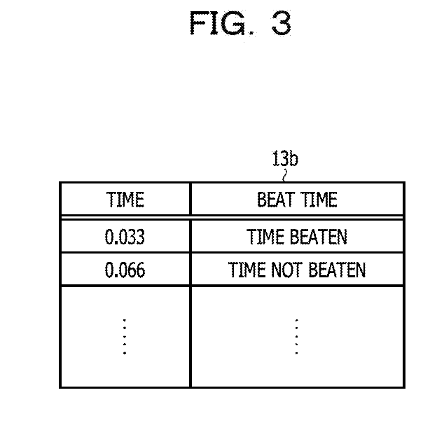

FIG. 3 is a diagram illustrating an example of timing data. The timing data 13b illustrated in the example in FIG. 3 includes respective fields for “time” and “timing of beating time”. Time from the start of a song and a dance is registered in the “time” field by an evaluation unit 14c, described later. In the “timing to beat time” field, “yes” is registered by the evaluation unit 14c, described later, if the time registered in the “time” field is the timing at which the player beats time, and “no” is registered if the time is not the timing at which the player beats time.

For example, in the first record of the timing data 13b illustrated in the example in FIG. 3, “yes” is registered in the “timing to beat time” field for the time 0.033 seconds after the start of the song and the dance, indicating that the time is the timing at which the player beats time. In the second record of the timing data 13b illustrated in the example in FIG. 3, “no” is registered in the “timing to beat time” field for the time 0.066 seconds after the start of the song and the dance. This indicates that the time is not the timing at which the player beats time.

The music tempo data 13c is data indicating the reference tempo. The reference tempo is acquired from sound information by the evaluation unit 14c, described later. Here, examples of the sound information may include, for example, sound collected by a non-illustrated microphone, a song played by a karaoke device, and audio data acquired in synchronization with the moving image data 13a in video data recorded using a non-illustrated video camera. In addition, as an example of the sound information, a musical instrument digital interface (MIDI) may be used.

The evaluation data 13d is an evaluation result of a tempo of a motion of each player evaluated by the evaluation unit 14c, described later. The evaluation result will be described later.

The storage unit 13 is, for example, a semiconductor memory element such as a flash memory or a storage device such as a hard disk or an optical disk.

The control unit 14 includes an internal memory for storing a program that specifies various kinds of processing procedures, and control data, based on which the control unit 14 performs various kinds of processing. As illustrated in FIG. 1, the control unit 14 includes the area control unit 14a, an acquisition unit 14b, the evaluation unit 14c, and the output control unit 14d.

The area control unit 14a is a processing unit that divides a captured image into plural evaluation target areas according to the number of players included in the captured image and generates dividing lines for the plural evaluation target areas.

Description follows regarding an embodiment of the area control unit 14a. First, the area control unit 14a determines the number of players included in the captured image. The area control unit 14a, for example, is able to identify the number of players included in the captured image, using the number of persons entered or selected by the user. Note that, in the present embodiment, the persons to dance may be selected from one up to the maximum of four persons, however, the embodiment is not limited thereto.

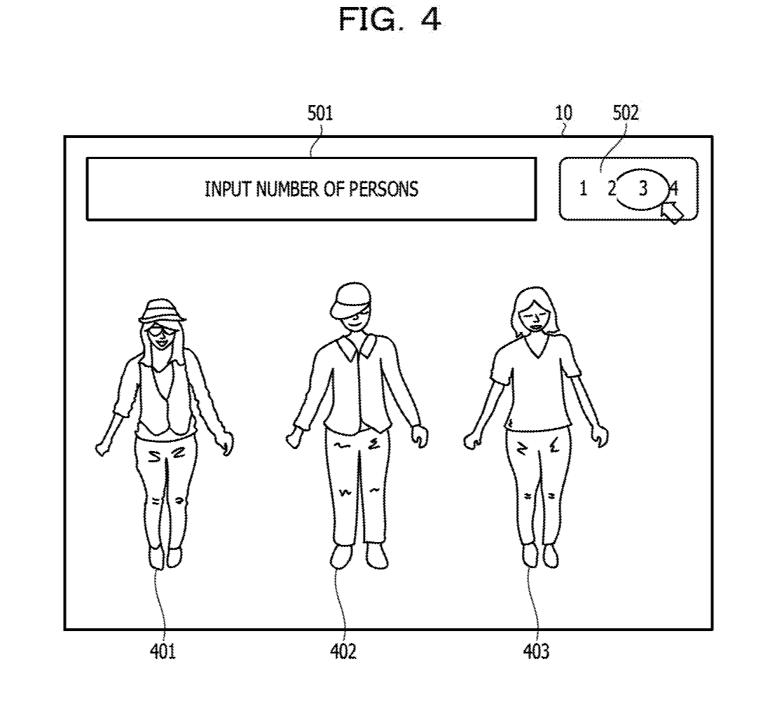

A configuration that uses the number of persons entered or selected by the user is described with reference to FIG. 4. FIG. 4 is a diagram illustrating an example of a number-of-persons selection screen according to the first embodiment. When an instruction to perform evaluation processing is received from the input unit 11, the area control unit 14a generates a screen as illustrated in FIG. 4 and outputs to the output control unit 14d.

As illustrated in FIG. 4, the number-of-persons selection screen is displayed with a message area 501 and a selection area 502 superimposed on a captured image. In the message area 501, a message prompting the user to select the number of players to dance is displayed. In the selection area 502, options to select the number of persons and a cursor are displayed. The user selects the number of persons in the selection area 502 using a non-illustrated pointing device, or the like. The input unit 11, upon receiving an instruction regarding the selection of the number of persons from the user, outputs the received instruction to the area control unit 14a.

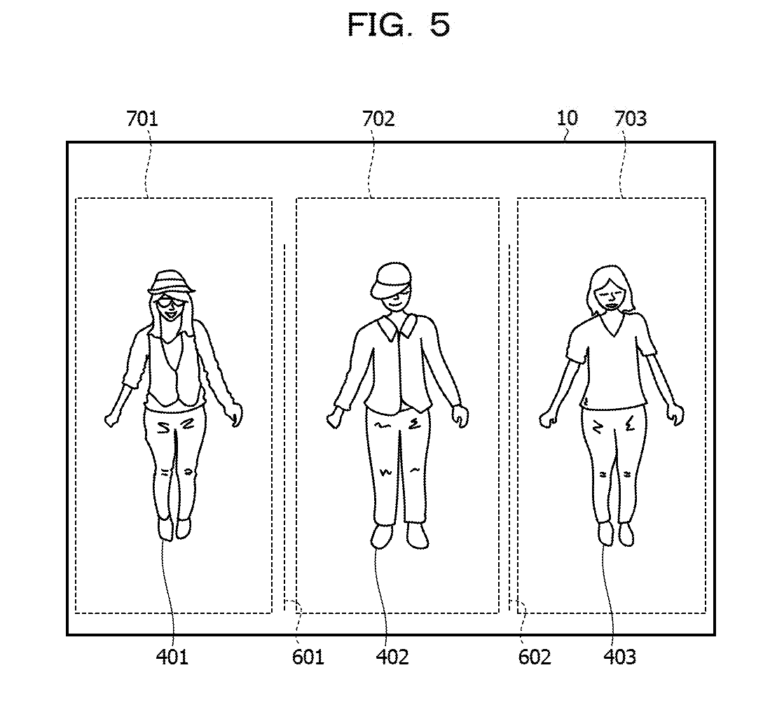

The area control unit 14a, upon receiving the instruction regarding the selection of the number of persons from the input unit 11, divides a frame into plural evaluation target areas according to the entered number of persons. The area control unit 14a, for example, divides the frame into areas with equal width according to the number of persons entered. FIG. 5 is a diagram illustrating an example of evaluation target areas according to the first embodiment. FIG. 5 illustrates, for example, an example of plural evaluation target areas set by the area control unit when the entered number of persons is three. The frame is divided into three evaluation target areas of evaluation target areas 701, 702, and 703 according to the number of persons.

The area control unit 14a further generates a display to indicate divided respective evaluation target areas and outputs to the output control unit 14d, so as to be displayed superimposed on the captured image. As illustrated in FIG. 5, the area control unit 14a causes the dividing line 601 dividing the evaluation target area 701 and the evaluation target area 702, to be displayed superimposed on the captured image. In the same way, the area control unit 14a causes a dividing line 602 dividing the evaluation target area 702 and the evaluation target area 703, to be displayed superimposed on the captured image.

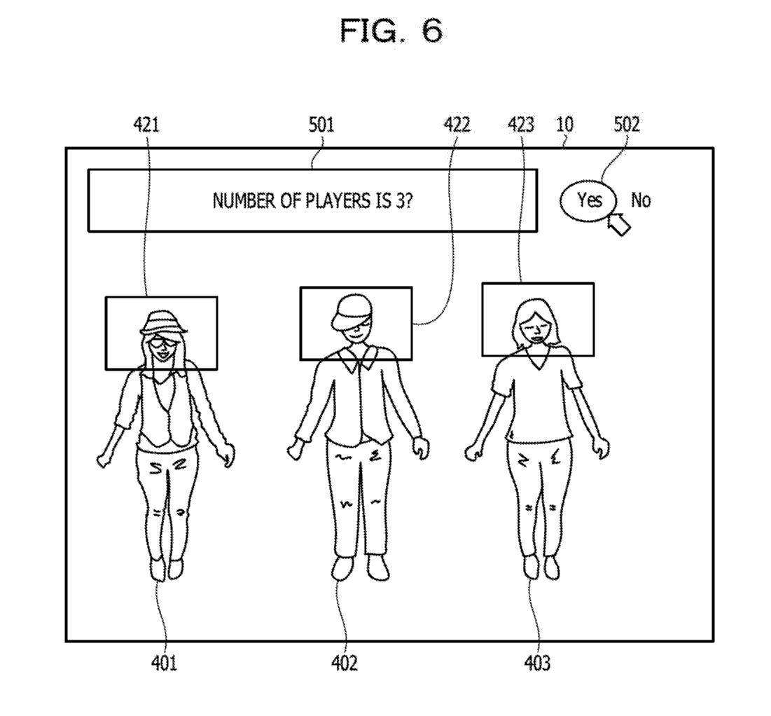

A configuration in which the area control unit 14a determines the number of players included in the captured image, based on an input or selection by the user, has been described, however a configuration is not limited thereto. For example, a configuration may be such that the area control unit 14a determines the number of players using a facial recognition technology or an object recognition technology. FIG. 6 is a diagram illustrating an example of number-of-persons determination processing using a facial recognition technology according to the first embodiment. As illustrated in FIG. 6, the area control unit 14a recognizes faces included in the captured image using a known facial recognition technology, as facial recognition areas 421 to 423 illustrates, and determines the number of players included in the captured image based on the recognized number of faces. In addition, the area control unit 14a causes a message as to whether the identified number of persons is correct or not to be displayed in the message area 501 and causes selectable options to be displayed in the selection area 502.

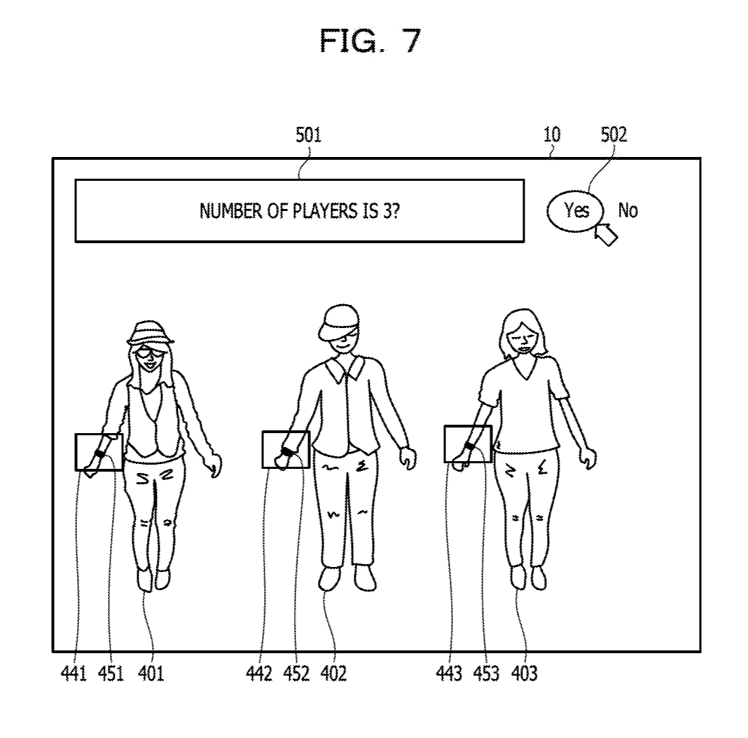

In cases in which the number of players is identified using object recognition technology instead of facial recognition technology, players to be included in the captured image each hold or wear an object to serve as a target of recognition, such as, for example, a wrist band or a musical instrument. FIG. 7 is a diagram illustrating an example of number-of-persons determination processing using object recognition technology according to the first embodiment. As illustrated in FIG. 7, using a known object recognition technology, the area control unit 14a recognizes objects included in the captured image and determines the number of players included in the captured image, based on the recognized number of objects. In the example illustrated in FIG. 7, the area control unit 14a recognizes wrist bands 451 to 453 worn by the respective players, as object recognition areas 441 to 443 illustrates, and determines that the number of players is three. In addition, the area control unit 14a causes a message to be displayed in the message area 501, as to whether or not the identified number of persons is correct and causes the selectable options to be displayed in the selection area 502.

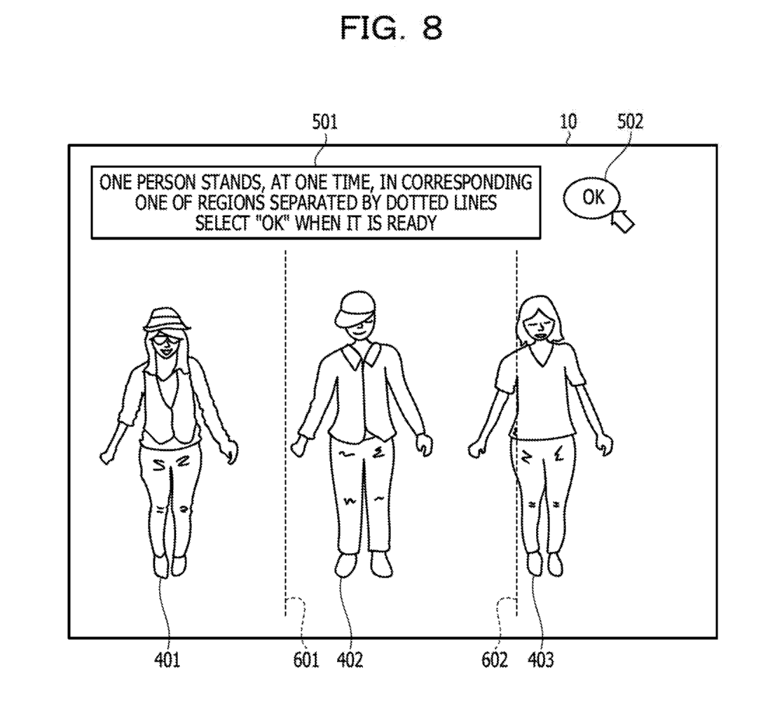

Note that a configuration may be such that the players are instructed by the area control unit 14a to enter the respective evaluation target areas. FIG. 8 is a diagram illustrating an example of the area partitioning display according to the first embodiment. The area control unit 14a causes the dividing lines 601 and 602 that divide the respective evaluation target areas to be displayed superimposed on the captured image as illustrated in FIG. 8. In addition, the area control unit 14a causes a message prompting the players to move inside the respective evaluation target areas to be displayed in the message area 501. In addition, the area control unit 14a may cause a selectable option to be displayed in the selection area 502, such that a readiness to start may be entered. The area control unit 14a instructs the acquisition unit 14b to start the evaluation processing, upon receiving the input from the input unit 11 that the “OK” has been selected.

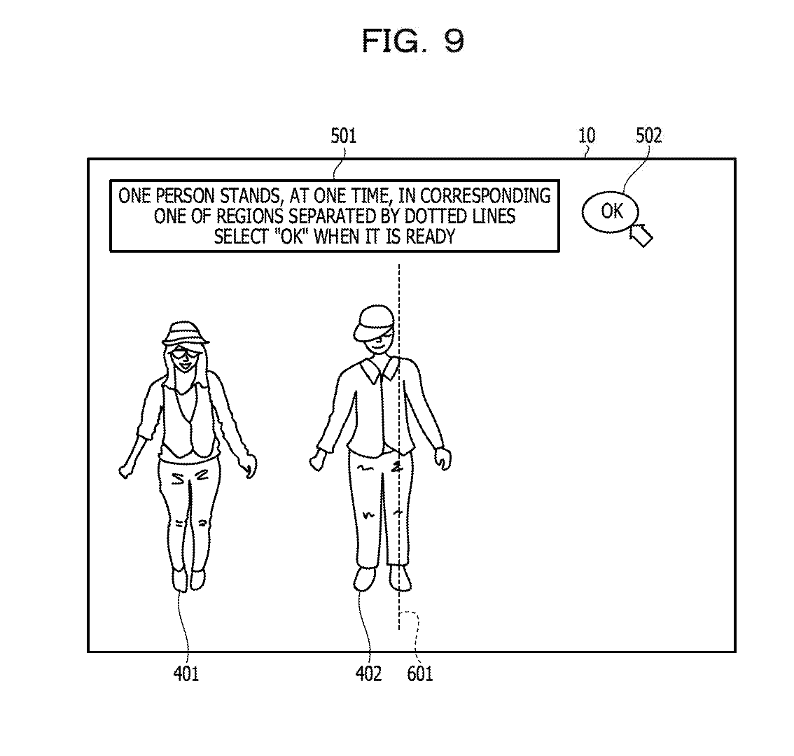

In the present embodiment, the area control unit 14a changes the display of the evaluation target areas and the dividing lines according to the identified number of players. FIG. 9 is a diagram illustrating another example of the area partitioning display according to the first embodiment. As illustrated in FIG. 9, when the number of players included in the captured image is two, the area control unit 14a causes one dividing line 601 to be displayed, dividing a frame into two right and left evaluation target areas. In the same way, when the number of players included in the captured image is four, the area control unit 14a causes three dividing lines to be displayed, dividing a frame into four evaluation target areas.

Note that the area control unit 14a may be configured such that a message is displayed prompting players to adjust positions to stand, when more than one players are standing in a single evaluation target area or when a player is standing on the dividing line when an “OK” is selected by the players. Alternatively, the area control unit 14a may be configured to start the next processing at the point of time it is confirmed that each player stands in the respective evaluation target area, without having the message and selectable options displayed.

Note that, in a configuration using facial recognition technology or object recognition technology, the area control unit 14a may be configured such that the evaluation target areas 701 to 703 are not preset. For example, the area control unit 14a may set areas within a certain range from the facial recognition area 421 illustrated in FIG. 6 or from the object recognition area 441 illustrated in FIG. 7, as the evaluation target areas. In this case, when the player A 401 moves, the area control unit 14a moves the evaluation target area according to the position of the player A 401.

Returning to the description of FIG. 1, the acquisition unit 14b is a processing unit that acquires difference between frames contained in the moving image. Specifically, the acquisition unit 14b acquires, for each of the plural frames contained in the moving image illustrated by the moving image data 13a, difference between a frame and a frame image-captured before the current frame. In addition, the acquisition unit 14b acquires, for each of the plural frames contained in the moving image illustrated by the moving image data 13a, difference between a frame and a frame obtained by accumulating frames image-captured before the current frame. In the present embodiment, the acquisition unit 14b acquires the difference for each of the divided area A 701 and area B 702 respectively.

Description of an embodiment of the acquisition unit 14b follows. For example, the acquisition unit 14b acquires the moving image data 13a stored in the storage unit 13, when an instruction to perform the evaluation processing, described later, is input from the input unit 11.

Next, for each of the divided area A 701 and area B 702, the acquisition unit 14b acquires difference between a frame and a frame image-captured before the current frame, using a background difference method, for each of the frames contained in the moving image illustrated by the moving image data 13a. For example, the acquisition unit 14b acquires, for each of the plural frames, difference between the frame and a frame obtained by accumulating frames image-captured before the current frame, using a known function related to accumulation of background statistics.

A description follows regarding processing in the acquisition unit 14b that uses the function related to accumulation of background statistics. For each of the corresponding evaluation target areas, the acquisition unit 14b compares a frame with background information obtained from frames that have been image-captured before the current frame, and generates a binarized image based on a change in luminance. Note that the information generated here is, for example, information in which a pixel with a change in luminance less than or equal to a threshold value is replaced by a black pixel and a pixel with a change in luminance greater than the threshold value is replaced by a white pixel, however, the information is not limited thereto. The acquisition unit 14b may generate an image other than an binarized image with black and white pixels, as long as, in the information provided, it is possible to identify whether a change in luminance is less than or equal to a threshold value, or greater than the threshold value.

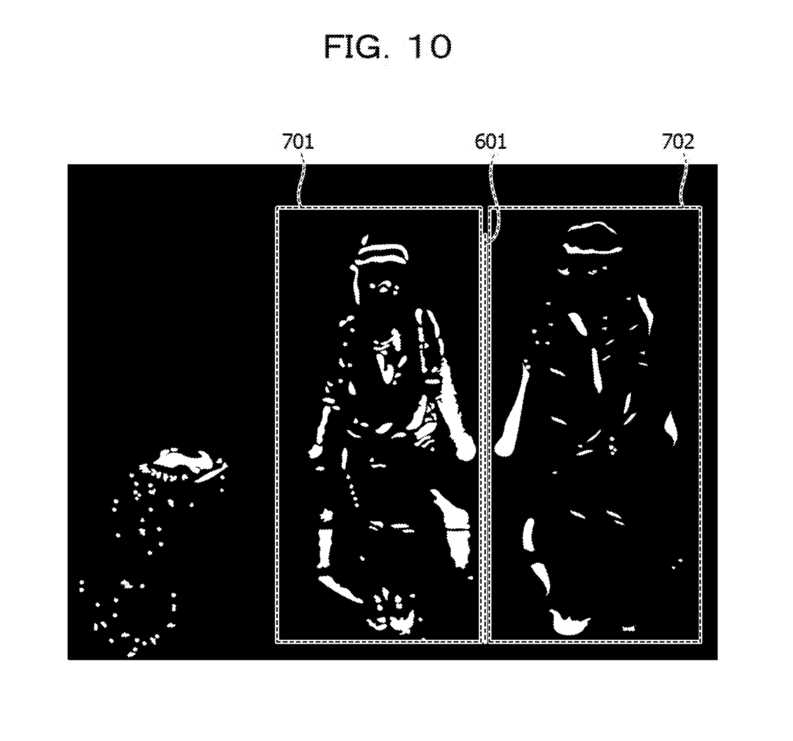

FIG. 10 is a diagram illustrating an example of a binarized image. FIG. 10 illustrates an example of a result of binarizing an entire frame image. The acquisition unit 14b, for example, compares the frame 15 illustrated in the previous FIG. 2 with background information obtained from frames image-captured before the frame 15 using the function related to accumulation of background statistics, for each of the corresponding evaluation target areas. Then, the acquisition unit 14b generates a binarized image such as the one illustrated in the example of FIG. 10, and for each of the corresponding evaluation target areas, the acquisition unit 14b calculates the total number of white pixels (background difference amount) included in the generated binarized image, as a motion amount of the player.

In this manner, in the present embodiment, the background difference amount in each of the divided evaluation target areas is used as an index indicating amount of movement by each player. For example, the acquisition unit 14b calculates, as the motion amount of the player A 401, the total number of white pixels included in a binarized image in the area A 701 on the left side of the imaging areas illustrated in the example of FIG. 10. Likewise, for example, the acquisition unit 14b calculates, as the motion amount of the player B 402, the total number of white pixels included in a binarized image in the area B 702 on the right side of the imaging areas illustrated in the example of FIG. 10.

In this way, for each of the evaluation target areas, the acquisition unit 14b acquires the background difference amount for each of the frames as the motion amount of each player. Then, for each frame, the acquisition unit 14b the background difference amount with a frame number.

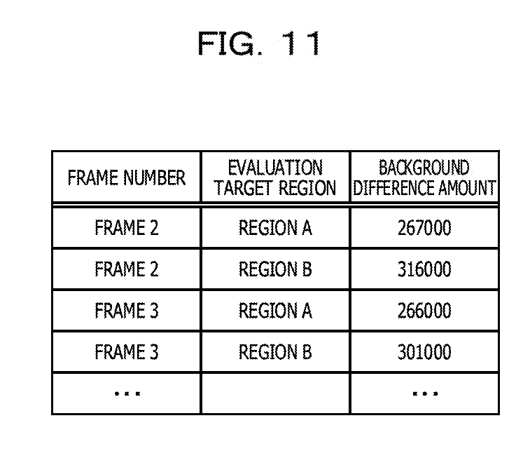

FIG. 11 is a diagram illustrating an example of setting association between background difference amount, evaluation target area, and frame number. In the example of FIG. 11, the acquisition unit 14b associates frame number “2”, “area A”, and background difference amount “267000” together. In the example of FIG. 11, the acquisition unit 14b also associates frame number “3”, “area A”, and background difference amount “266000” together. As illustrated in FIG. 11, the “area B” is also associated with a background difference amount and a frame number and registered by the acquisition unit 14b.

In this way, for each of the plural frames, the acquisition unit 14b acquires difference between a frame and a frame obtained by accumulating frames image-captured before the current frame, for each of the evaluation target areas.

Note that, the acquisition unit 14b may also acquire difference between a frame and a frame image-captured before the current frame, and acquire difference between a frame and a frame obtained by accumulating frames image-captured before the current frame, by using code book method.

Returning to the description of FIG. 1, the evaluation unit 14c is a processing unit to evaluate a motion of each of players. The evaluation unit 14c detects a timing at which an amount of a temporal change in continuously image-captured frames temporarily decreases. In the present embodiment, the evaluation unit 14c respectively detects such timing for each of the evaluation target areas.

A description follows regarding an embodiment of the evaluation unit 14c. For example, the evaluation unit 14c detects a frame having a smaller background difference amount than the background difference amount of an immediately preceding frame, also having a smaller background difference amount than the background difference amount of an immediately following frame, based on information in which frame number and background difference amount are associated with each other by the acquisition unit 14b.

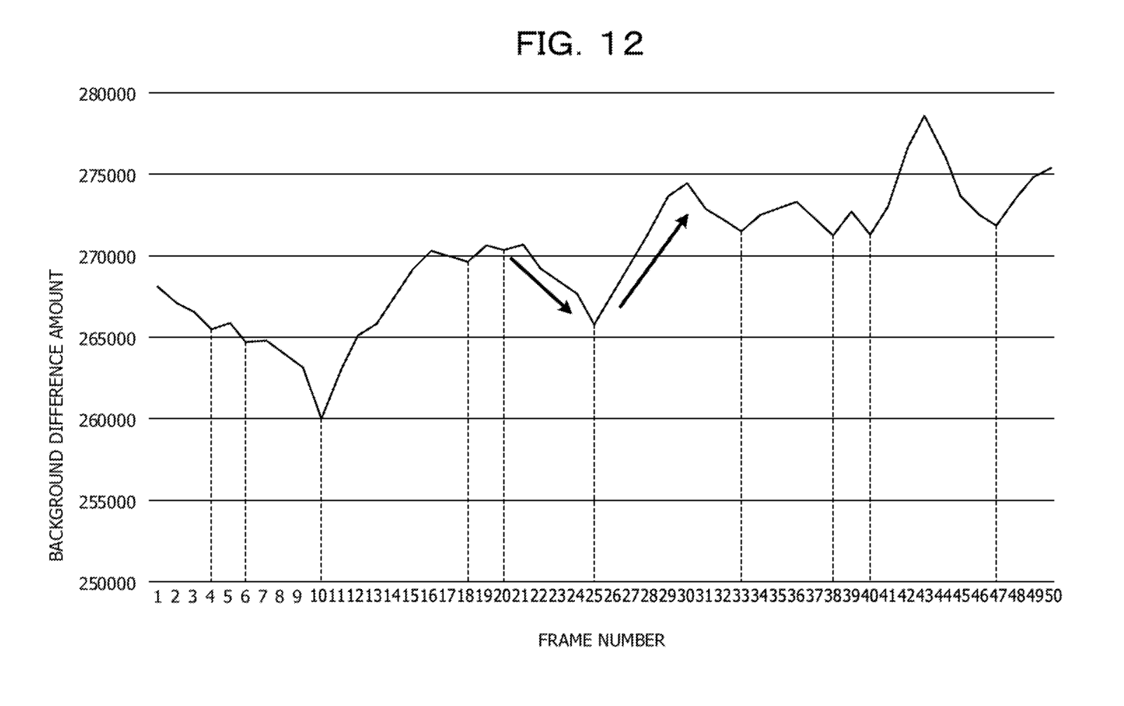

FIG. 12 is a diagram for explaining an example of processing performed by the evaluation device according to the first embodiment. The example in FIG. 12 illustrates a graph, with frame numbers on a horizontal axis and background difference amount on a vertical axis, indicating a relationship between a frame number and a background difference amount, associated with by the acquisition unit 14b, in the area A 701 on the left side of the diagram in FIG. 10. The graph illustrated in the example of FIG. 12 indicates background difference amounts for frames with frame numbers “1” to “50”.

When, as illustrated in the graph of the example of FIG. 12, frame numbers and background difference amounts are associated with each other by the acquisition unit 14b, the evaluation unit 14c performs the following processing. Namely, the evaluation unit 14c detects a frame with the frame number “4”, for which, background difference amount is smaller than the background difference amount of a frame with the frame number “3”, and background difference amount is smaller than the background difference amount of a frame with the frame number “5”. In the same way, the evaluation unit 14c detects frames with respective frame numbers “6”, “10”, “18”, “20”, “25”, “33”, “38”, “40”, and “47”.

Then, the evaluation unit 14c detects the time at which the detected frames are image-captured, as respective timings at which the amount of a temporal change in frames temporarily decreases. For example, the evaluation unit 14c detects the time at which the frames with frame numbers “4”, “6”, “10”, “18”, and “20” are respectively image-captured as the timings at which the amount of temporal change in frames temporarily decreases. In addition, the evaluation unit 14c also detects, for example, the time at which the frames with frame numbers “25”, “33”, “38”, “40”, and “47”, are respectively image-captured as the timings at which the amount of temporal change in frames temporarily decreases. In the present embodiment, the evaluation unit 14c also detects timings in the area B 702 on the right side of the diagram in FIG. 10.

In addition, based on detected timings, the evaluation unit 14c extracts a motion in which a player included in a frame beats time, or a timing at which the player beats time. In the present embodiment, the evaluation unit 14c individually extracts the said timing for each player in the respective evaluation target areas.

The evaluation unit 14c extracts, for example, the following timing from detected timings. Namely, for each of the evaluation target areas, the evaluation unit 14c extracts a frame satisfying a predetermined condition out of frames image-captured at the time of detection, and extracts the time when the frame was image-captured as timing at which a player included in the frame beats time.

Here, a description follows regarding an example of a method used by the evaluation unit 14c to extract a frame satisfying a predetermined condition. The evaluation unit 14c, for example, selects, one by one, frames corresponding to the timing of respective detection (frames image-captured at the timing of detection) as an extraction candidate frame. Then, the evaluation unit 14c performs the following processing each time the evaluation unit 14c selects an extraction candidate. Namely, the evaluation unit 14c determines whether or not the background difference amount decreases starting from a frame a predetermined numbers of frames before the extraction candidate frame through the extraction candidate frame, and the background difference amount increases starting from the extraction candidate frame through a frame a predetermined numbers of frames after the extraction candidate frame.

When the evaluation unit 14c determines that the background difference amount decreases starting from the frame the predetermined numbers of frames before the extraction candidate frame through the extraction candidate frame, and the background difference amount increases starting from the extraction candidate frame through the frame the predetermined numbers of frames after the extraction candidate frame. the evaluation unit 14c performs the following processing. Namely, the evaluation unit 14c extracts the time in which the extraction candidate frame was image-captured as the timing at which a player included in the frame beats time. In other words, the evaluation unit 14c extracts a motion of beating time performed by a player included in the extraction candidate frame, out of motions of respective players indicated in the plural frames. Then, the evaluation unit 14c performs the above-mentioned processing on all frames corresponding to the respective detected timings.

A description follows regarding a case in which, in the area A 701 on the left side illustrated in FIG. 10, the predetermined number is “4”, for example, and frame numbers and background difference amounts are associated with each other by the acquisition unit 14b as illustrated in the graph in the example of FIG. 12. In this case, since the background difference amount decreases starting from a frame with the frame number “21” through the frame with the frame number “25” and increases from the frame with the frame number “25” to a frame with the frame number “29”, the evaluation unit 14c performs the following processing. Namely, the evaluation unit 14c extracts the time in which the frame with the frame number “25” is image-captured, as the timing at which a player included in the frame beats time.

In addition, the evaluation unit 14c extracts a motion of beating time, performed by a player included in the frame with the frame number “25”, out of motions of players indicated in each of the plural frames. Regarding the above-mentioned predetermined numbers, a predetermined number of frames before the extraction candidate frame and a predetermined number of frames after the extraction candidate frame may be set to difference values. An embodiment in which the predetermined number of frames before the extraction candidate frame is set to “5” and the predetermined number of frames after the extraction candidate frame is set to “1” may be considered as an example.

In addition, out of timing in which respective plural frames are image-captured, time to beat time, and “time beaten” are associated by the evaluation unit 14c and registered in the timing data 13b, as illustrated in FIG. 3. Further, out of timing in which respective plural frames are image-captured, time not to beat time, and “time not beaten” are associated by the evaluation unit 14c and registered in the timing data 13b, as illustrated in FIG. 3. In the present embodiment, for each player present in the respective evaluation target areas, the evaluation unit 14c individually registers either of the timing which is time to beat time and the timing which is not the time to beat time.

In this manner, the timing data 13b, which is registered with various kinds of information, is used to evaluate, for example, a rhythm of a player, indicated by the timing at which the player beats time. For each of all the frames, the evaluation unit 14c registers in the timing data 13b, either “time to beat time” and “time beaten” associated each other, or “time not to beat time” and “time not beaten” associated each other.

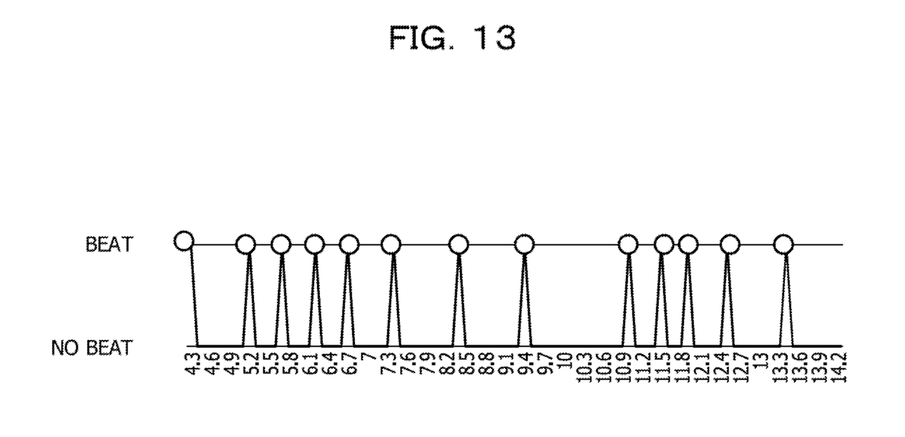

FIG. 13 is a diagram illustrating an example of a graph obtained by plotting timings at which a person beats time indicated by the timing data. Note that a horizontal axis in FIG. 13 indicates time (seconds) and a vertical axis indicates whether or not the person beats time. In the example of FIG. 13, whether or not it is a timing for the player to beat time is plotted at intervals of 0.3 seconds.

In the example of FIG. 13, for example, if the player has had beaten time within every successive nine frames to be image-captured, then a circle is plotted at a “TIME BEATEN” position. If, in the example of FIG. 13, the player has had not beaten time within every successive nine frames to be image-captured, then, no circle is plotted at a “TIME BEATEN” position. In the example of FIG. 13, for example, a circle is plotted at a “TIME BEATEN” position corresponding to time “4.3 seconds”. This indicates that the player has had beaten time within the nine frames, each frame corresponding to one thirtieth of a second in a time period from 4.0 seconds to 4.3 seconds. In the example of FIG. 13, for example, no circle is plotted corresponding to time “4.6 seconds”. This indicates that the player has had not beaten time within the nine frames, each frame corresponding to one thirtieth of a second in a time period from 4.3 seconds to 4.6 seconds. The same applies to the other time. Note that FIG. 13 conceptually illustrates an example of the timing data and timing data may take an appropriate mode other than that illustrated in FIG. 13.

In addition, the evaluation unit 14c performs evaluation related to the tempi of the motions of the respective players according to a comparison between a reference tempo and tempi indicated by motions of beating time, performed by players included in respective evaluation target areas in frames, or timings at which the players beat time, the tempi being extracted based on the plural frames. Furthermore, the evaluation unit 14c performs evaluation related to the motions of the respective players, based on a tempo extracted from a reproduced song (music) and on timings at which the respective players keep rhythm and which are acquired from frames including, as image-capturing targets, the respective players singing to the reproduced song.

The evaluation unit 14c acquires, from the timing data 13b, time of a timing at which a player beats time. In addition, the evaluation unit 14c acquires the reference tempo from the sound information. The evaluation unit 14c performs the following processing on sound information including, for example, a voice of a player who sings and dances to the reproduced song collected by a non-illustrated microphone provided in a karaoke box and the reproduced song, and the like. Namely, the evaluation unit 14c acquires the reference tempo using technologies such as beat tracking and rhythm recognition. To perform the beat tracking and the rhythm recognition, for example, technologies described in a non-patent literature are available (Takeda, Haruto, “2-4 Audio Alignment, Beat Tracking, and Rhythm Recognition”, the Institute of Electronics, Information and Communication Engineers, “Know/edge Base”, Volume 2, Section 9, Chapter 2, page 17 to page 20, online, searched on Dec. 17, 2013, the URL http://www.ieice-hbkb.org/portal/doc_557.html). Alternatively, the evaluation unit 14c may acquire the reference tempo from MIDI data corresponding to the reproduced song. In addition, the evaluation unit 14c stores, as the music tempo data 13c, the acquired reference tempo in the storage unit 13.

In addition, the evaluation unit 14c performs a comparison between a timing of a beat in the reference tempo indicated by the music tempo data 13c and a timing at which a player beats time, acquired from the timing data 13b.

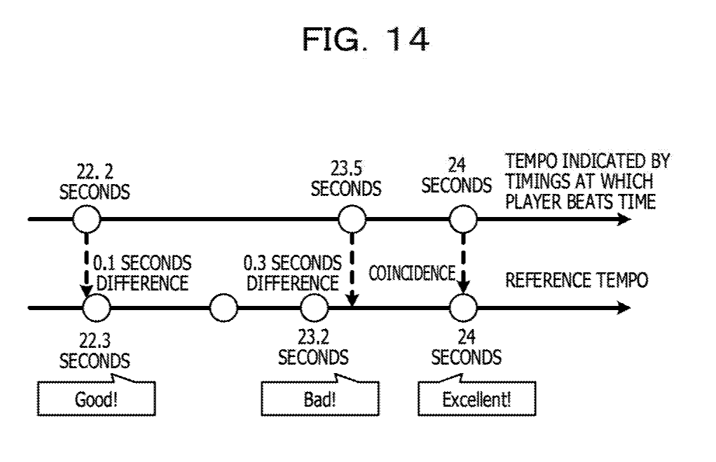

The evaluation unit 14c compares timings by using, for example, the timing at which the player beats time, as a reference. FIG. 14 is a diagram illustrating an example of a method for comparing timings. The example in FIG. 14 illustrates a tempo indicated by timings at which the player A 401 located in the evaluation target area 701 on the left side beats time, and a reference tempo. Note that, in FIG. 14, circles on an upper stage indicate timings at which the player beats time, whereas circles on a lower stage indicate timings of beats in the reference tempo.

In the example of FIG. 14, the evaluation unit 14c calculates difference between each of the timings at which the player beats time and a timing temporally closest thereto out of the timings of beats in the reference tempo. Then, the evaluation unit 14c calculates points corresponding to the magnitude of difference and adds the calculated points to a score. When the difference is, for example, “0” second (a first threshold), the evaluation unit 14c defines the timing as “Excellent!” and adds “2” points to the score of evaluation. When the difference is greater than “0” second and is less than or equal to “0.2” seconds (a second threshold), the evaluation unit 14c defines the timing as “Good!” and adds “1” point to the score of evaluation. In addition, when the difference is greater than “0.2” seconds, the evaluation unit 14c defines the timing as “Bad!” and adds “−1” point to the score of evaluation. In the present embodiment, the evaluation unit 14c also calculates points in the area B 702 illustrated in FIG. 10 in the same way.

The evaluation unit 14c calculates difference and adds to the score points corresponding to the difference, with respect to all of the timings at which the player beats time. Note that the score is set to 0 point at the start of the evaluation processing. In addition, the first threshold and the second threshold are not limited to the above-mentioned values, and any given values may be adopted as the first threshold and the second threshold.

In the example of FIG. 14, the evaluation unit 14c calculates difference “0.1 seconds” between a timing at which the player beats time (22.2 seconds) and the timing of a beat in the reference tempo (22.3 seconds), and defines the timing as “Good!” adding “1” point to the score of evaluation. The evaluation unit 14c calculates difference “0.3 seconds” between a timing at which the player beats time (23.5 seconds) and the timing of a beat in the reference tempo (23.2 seconds), and defines the timing as “Bad!” adding “−1” point to the score of evaluation. Further, the evaluation unit 14c calculates difference “0 second” between a timing at which the player beats time (24 seconds) and the timing of a beat in the reference tempo (24 seconds) and defines the timing as “Excellent!” adding “2” points to the score of evaluation.

Note that the evaluation unit 14c may compare timings using the timing of a beat in the reference tempo as a reference. At that time, as a timing indicated by the reference tempo used for evaluation, a timing between timings acquired from the sound information, what is referred to as backbeat, may be added. This thereby enables a rhythm of a player who beats time at a timing of a backbeat to be appropriately evaluated. By taking into consideration the fact that it is more difficult to beat time with a backbeat than to beat time at a timing acquired from the sound information (a downbeat), a mode may be adopted in which a higher score is added when a timing at which a player beats time matches a backbeat than the score to be added when the timing matches a downbeat.

When the evaluation unit 14c has added points to the score, for all the timings at which the player beats time, or for the timings of all the beats in the reference tempo, the evaluation unit 14c calculates evaluation by using the score. The evaluation unit 14c may use, for example, the score itself as an evaluation or may calculate scored points on a 100-point scale, based on the following Expression (1).

Scored Points (Out of 100 points)=Basic Points+(Value of Score/(Number of Beats×“Excellent” Points))×(100−Basic Points) (1)

In the above-mentioned Expression (1), the “basic points” indicate a minimum points that can be acquired, such as 50 points. The “number of beats” indicates the number of all the timings at which the player beats time or the number of timings of all the beats in the reference tempo. The “Excellent” points indicate “2”. Accordingly, in Expression (1), the denominator in the fractional term corresponds to a maximum acquirable score. In addition, when all the timings are judged “Excellent!”, Expression (1) is calculated to be 100 points. Moreover, in the Expression (1), 50 points are provided even when all the timings are judged “Bad!”, thereby enabling the motivation of the player who dances to be maintained.

In addition, when Expression (1) is used, the evaluation unit 14c is capable of calculating a score such that the value of the score increases with an increase in the number of timings at which the player beats time and an increase in the number of timings at which a difference from the timing indicated by the reference tempo is smaller than a predetermined value. This enables the tempo of the motion of the player to be evaluated from the viewpoint of whether the timings at which the player beats time matches the respective timings indicated by the reference tempo. Note that the above-mentioned Expression (1) is just an example and the evaluation unit 14c may use another mathematical expression in which points increase in response to the number of evaluation of “Excellent!”.

Next, the evaluation unit 14c stores the calculated evaluation in the storage unit 13 as the evaluation data 13d and transmits the evaluation to the output control unit 14d. In addition, at the time when all evaluation is finished, for example, at the time when a song ended, the evaluation unit 14c aggregates evaluation results of respective players, generates information to be displayed in a result display screen to be described later, and outputs the information to the output control unit 14d.

Returning to the description of FIG. 1, the output control unit 14d is a processing unit for controlling output of processing results by the respective processing units. Specifically, the output control unit 14d controls such that various kinds of screens generated by the area control unit 14a are output. For example, the output control unit 14d controls screens illustrated in, FIG. 4 to FIG. 9 to be displayed.

In addition, the output control unit 14d performs control so as to output an evaluation result serving as a result of an evaluation, received from the evaluation unit 14c. The output control unit 14d transmits the evaluation result to, for example, the output unit 12 so that the output unit 12 outputs the evaluation result.

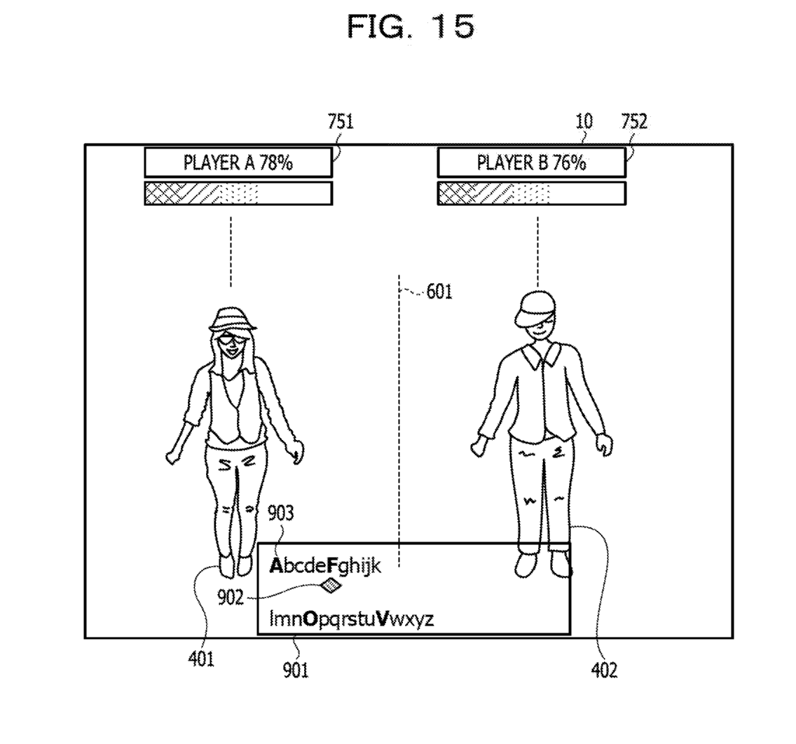

A description follows regarding an example of an evaluation result with reference to FIG. 15. FIG. 15 is a diagram illustrating an example of an evaluation display screen. In FIG. 15, the output control unit 14d causes an evaluation result 751 of the player A 401 to be output so that the position of the face of the player A 401 matches a lateral coordinate thereof. In the same way, the output control unit 14d causes an evaluation result 752 of the player B 402 to be output so that the position of the face of the player B 402 matches a lateral coordinate thereof. As exemplified in FIG. 15, the evaluation results 751 and 752 of the respective players each include a display identifying the player, a numerical value indicating a score, and a bar graph indicating the score. Note that a configuration may be such that, when a player moves, the output control unit 14c causes the display of an evaluation result to be moved along therewith.

In addition, the output control unit 14d performs a control such that an indication of a reference tempo that is a timing at which each player beats time is displayed. For example, as illustrated by a symbol 901 in FIG. 15, the output control unit 14d causes the reference tempo to be displayed along with lyrics in addition to the evaluation result of the respective players.

As illustrated by the symbol 901 in FIG. 15, the output control unit 14d causes a portion corresponding to the reference tempo to be highlighted as illustrated by a symbol 903. A character corresponding to, for example, a portion indicating the reference tempo is displayed in distinction from other characters in such a manner as being larger and in different color compared with other characters of the lyrics, or blinked. In addition, the output control unit 14d causes a cursor 902 to indicate a portion corresponding to the current lyrics. The cursor 902 moves along with the lyrics with the progress of a song. This enables each of the players to visually recognize a currently sung part and a timing of beating time.

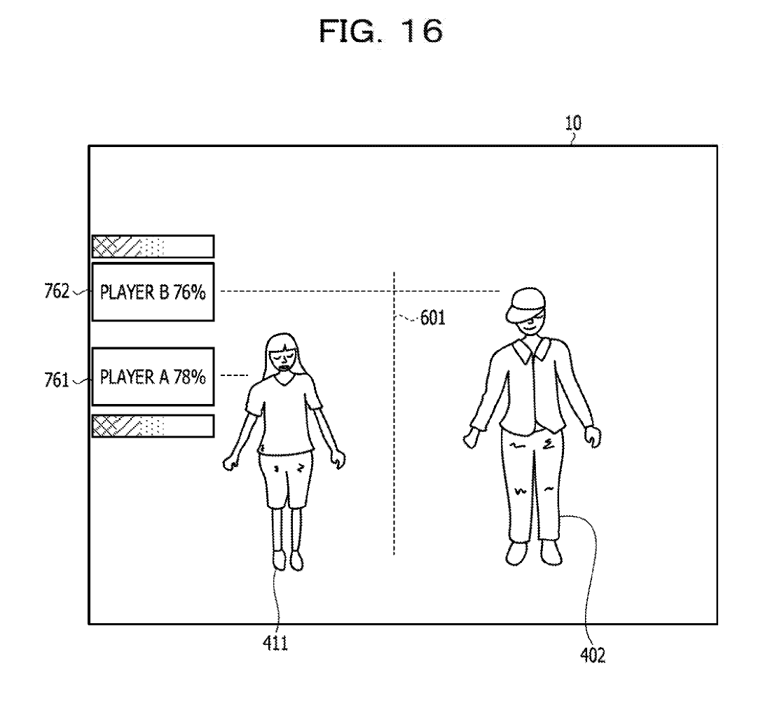

In FIG. 15, an example in which the output control unit 14d outputs evaluation results so that the positions of the faces of the respective players and the respective lateral coordinates thereof match each other. However, a configuration of displaying evaluation results is not limited thereto. A configuration may be such that the output control unit 14d outputs evaluation results so that the positions of the faces of the respective players and respective vertical coordinates thereof match each other. FIG. 16 is a diagram illustrating another example of the evaluation display screen. In FIG. 16, the output control unit 14d causes an evaluation result 761 of a player A 411 to be output so that the position of the face of the player A 411 matches a vertical coordinate thereof. In the same way, the output control unit 14d causes an evaluation result 762 of the player B 402 to be output so that the position of the face of the player B 402 matches a vertical coordinate thereof. According to such a configuration, for example, when difference between the body heights of the players is large, in such cases in which an adult and a child dance together, the output control unit 14d is able to present evaluation results of the respective players in an easily recognizable form. Note that a configuration may be such that the output control unit 14d causes the evaluation results of the respective players to be displayed in the vicinity of the faces of the respective players or to be displayed superimposed with the bodies of the respective players. Alternatively, configuration may be such that the output control unit 14d causes the evaluation results of the respective players to be displayed at plural positions out of positions corresponding to the positions of the faces of the respective players, positions located around the positions of the faces of the respective players, and positions at which the vertical coordinates or lateral coordinates thereof correspond to the positions of the faces of the respective players.

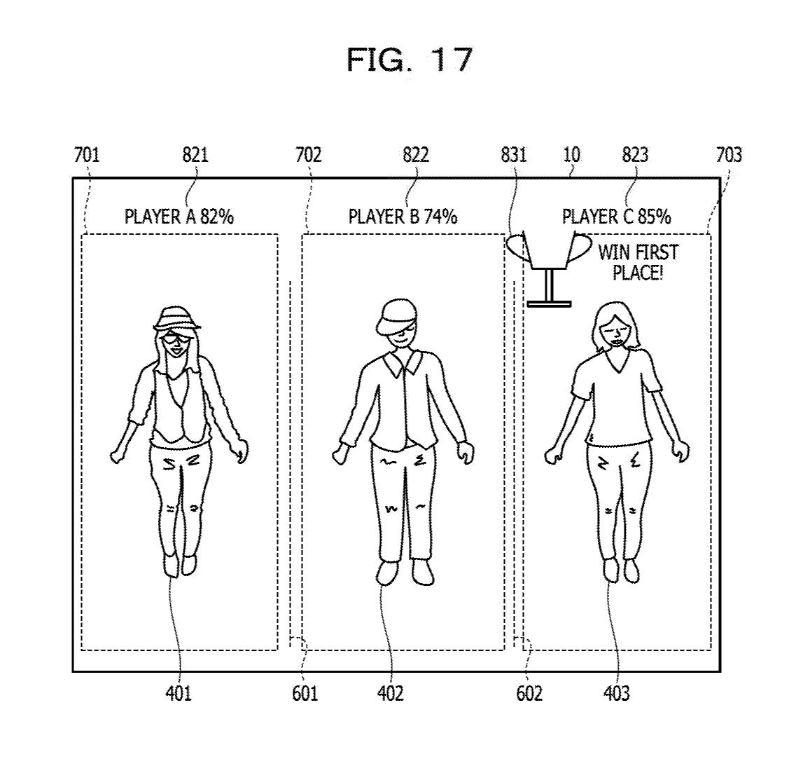

In addition, at the time when, for example, a song ended, the output control unit 14d performs a control so as to output the result display screen using information entered by the evaluation unit 14c. FIG. 17 is a diagram illustrating an example of a result display screen according to the first embodiment. As illustrated by symbols 821 to 823 in FIG. 17, the result display screen includes displays of scores that are the evaluation results of the respective players. In addition, as illustrated by a symbol 831, the result display screen further includes a display informing that a player C 403 whose score is the highest wins first place.

Returning to the description of FIG. 1, the control unit 14 may be implemented by a circuit such as an application specific integrated circuit (ASIC), a field programmable gate array (FPGA), a central processing unit (CPU), or a micro processing unit (MPU).

Flow of Processing

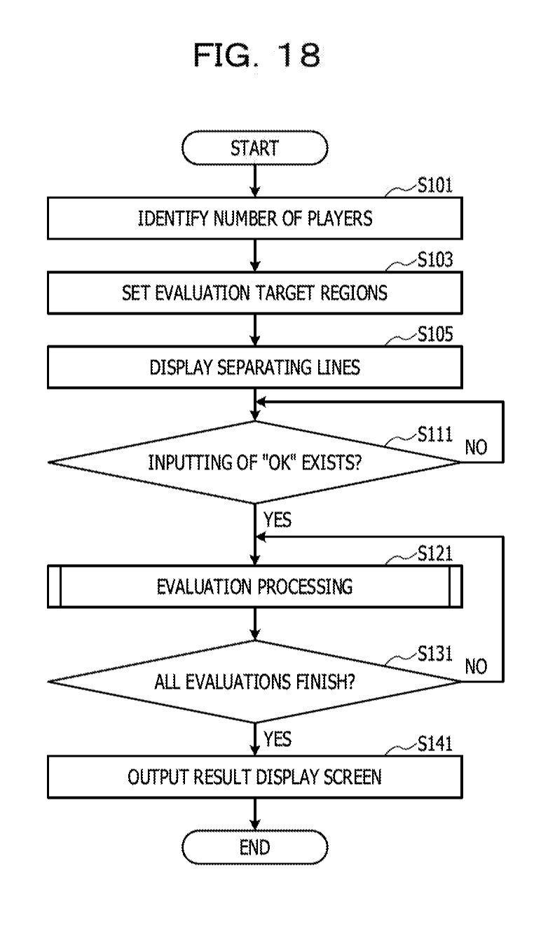

Next, a description follows regarding a flow of processing performed by the evaluation device 10 according to the first embodiment. FIG. 18 is a flowchart illustrating an example of processing according to the first embodiment. When, for example, the input unit 11 inputs an instruction to perform the evaluation processing to the control unit 14, the evaluation processing according to the embodiment is performed by the control unit 14.

First, the area control unit 14a determines the number of players included in a captured image (step S101). Next, according to the identified number of persons, the area control unit 14a sets evaluation target areas (step S103) and causes dividing lines to be displayed superimposed on the captured image (step S105).

Next, the area control unit 14a waits until reception of input of “OK” as illustrated by a symbol 502 in FIG. 8, “OK” indicating that each of the players to be included in the captured image has moved inside the respective evaluation target areas (step S111: No). Upon receiving the input of “OK” (step S111: Yes), the area control unit 14a instructs the acquisition unit 14b to perform the evaluation processing (step S121).

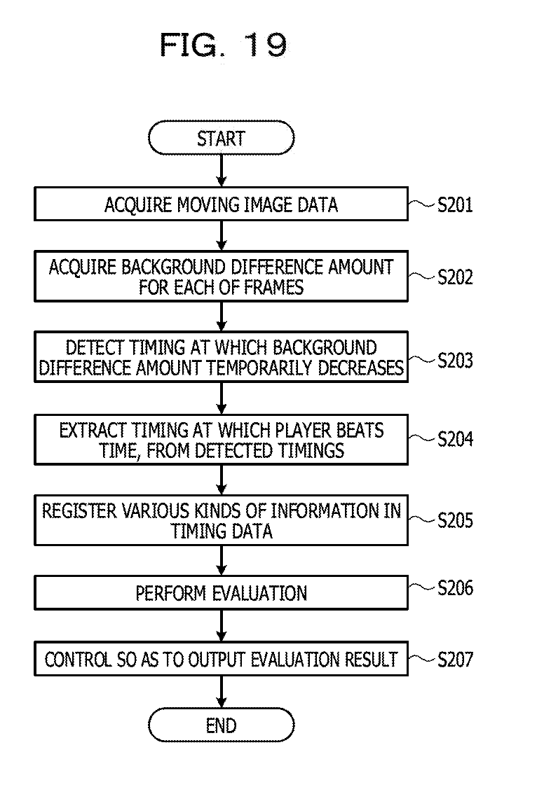

FIG. 19 is a flowchart illustrating an example of evaluation processing according to the first embodiment. As illustrated in FIG. 19, the acquisition unit 14b acquires the moving image data 13a stored in the storage unit 13 (step S201). Then, for each of frames, the acquisition unit 14b acquires a background difference amount serving as a motion amount of each player and associates the background difference amount and a frame number together (step S202).

Next, the evaluation unit 14c detects a timing at which an amount of a temporal change in continuously image-captured frames temporarily decreases (step S203). Then, based on the timing of the detection, the evaluation unit 14c extracts a motion of beating time, performed by each of the players included in a frame, or a timing at which the relevant player beats time (step S204).

Next, the evaluation unit 14c registers, in the timing data 13b illustrated in FIG. 3, “time to beat time” and “time beaten” associated each other, out of timing in which respective plural frames are image-captured. In addition, the evaluation unit 14c registers, in the timing data 13b illustrated in FIG. 3, “time not to beat time” and “time not beaten” associated each other out of timing in which respective plural frames are image-captured (step S205). Then, the evaluation unit 14c performs an evaluation (step S206). The output control unit 14d transmits an evaluation result to the output unit 12 such that the evaluation result is output from the output unit 12 (step S207).

The acquisition unit 14b repeats the evaluation processing in step S121 until all evaluation is finished (step S131: No). When all the evaluation is finished (step S131: Yes), the evaluation unit 14c outputs information indicating evaluation results to the output control unit 14d. The output control unit 14d performs control so as to output a result display screen (step S141) and processing ends.

As described above, in the present embodiment, the evaluation device divides an imaging area into plural evaluation target areas and evaluates a motion of one player for each of the evaluation target areas. This enables a motion of each player to be adequately evaluated without being affected by a motion of a specific player, since the evaluation device does not evaluate motions of plural players.

If the evaluation device performs recognition processing for identifying individual players in order to detect motions of plural players within the same area. This may render the processing load of the evaluation device high, and if the image-capturing accuracy of the evaluation device is low or the processing capacity of the evaluation device is low, the evaluation device may be restricted from performing sufficient evaluation. In the present embodiment, the evaluation device detects a motion of a single player in each of the divided evaluation target areas. Accordingly, the evaluation device is capable of evaluating dance of plural persons in a simple manner, without performing a recognition processing with high processing volume (with high processing load).

Furthermore, in the evaluation device in the present embodiment, an indication of separation into each divided area is displayed superimposed on the display device. This, accordingly, enables each person to recognize target areas for the evaluation of a dance.

In addition, in the above-mentioned first embodiment, a configuration in which the evaluation device performs an evaluation of whether a timing at which a player beats time matches a timing indicated by the reference tempo is described. However, the evaluation device is not limited thereto. The evaluation device may, for example, separate a time period into plural intervals and perform, for each of the intervals, an evaluation of whether the number of timings at which a player beats time and the number of timings indicated by the reference tempo match each other.

Note that, in the above-mentioned first embodiment, a configuration in which the evaluation device performs an evaluation of whether a timing at which a player beats time and a timing indicated by the reference tempo match each other is described. However, the evaluation device is not limited thereto. The evaluation device may, for example, separate a time period into plural intervals and perform, for each of the intervals, an evaluation of whether the number of timings at which a player beats time and the number of timings indicated by the reference tempo match each other. In addition, the evaluation device may perform an evaluation of, for example, whether an amount of a motion of a player and a melody expressed by, for example, “aggressive”, “slow”, or the like indicated by the reference tempo match each other.

### Second Embodiment

In the above-mentioned embodiment, by outputting a visual effect according to an evaluation at the time of displaying the evaluation of a dance of a player, the evaluation device is able to cause the player to clearly recognize the evaluation and to provide a service with a high entertainment property. Therefore, a description follows regarding a configuration in which the evaluation device outputs a visual effect according to an evaluation of a dance of a player as a second embodiment.

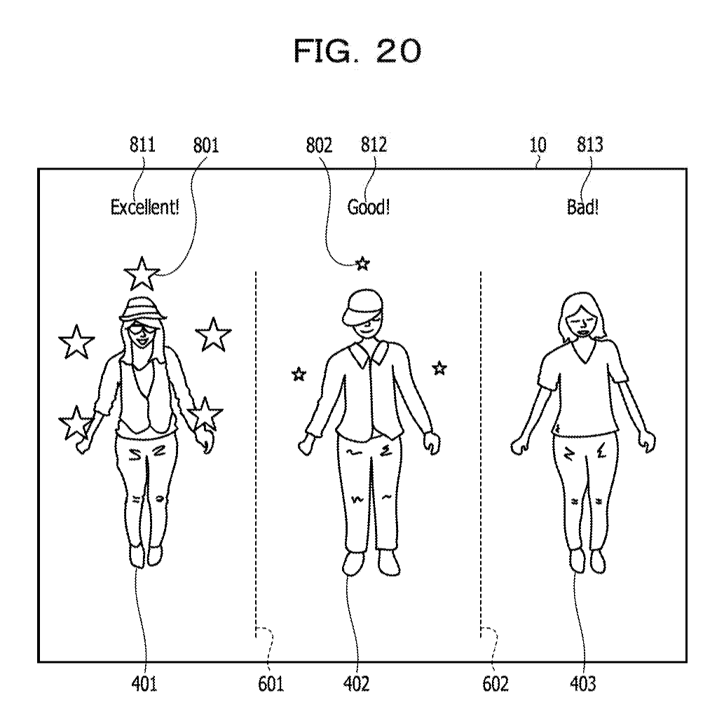

In the present embodiment, for example, according to an evaluation result of each of the players, the output control unit 14d of the evaluation device 10 causes a visual effect indicating the corresponding evaluation result to be output in the vicinity of the respective player. FIG. 20 is a diagram illustrating an example of a visual effect according to the second embodiment. As illustrated in FIG. 20, the output control unit 14d outputs a visual effect according to the grade of the evaluation of each of players.

The output control unit 14d outputs a message 811 of “Excellent!”, when a difference between a timing at which the player A 401 beats time and a timing of a beat in the reference tempo is, for example, “0 second”. Furthermore, the output control unit 14d causes a large star-shaped visual effect 801 to be output around the player A 401 according to an evaluation result of “Excellent!”

In addition, the output control unit 14d outputs a message 812 of “Good!” when a difference between a timing at which the player B 402 beats time and a timing of a beat in the reference tempo is, for example, “0.1 seconds”. Furthermore, the output control unit 14d causes a small star-shaped visual effect 802 to be output around the player B 402. In the same way, when a difference between a timing at which the player C 403 beats time and a timing of a beat in the reference tempo is, for example, “0.3 seconds”, the output control unit 14d causes a message 813 of “Bad!” to be output. In this case, the output control unit 14d causes no visual effect to be output around the player C 403.

In this way, the output control unit 14d visually depicts an evaluation result, based on, for example, the number and size of stars. This enables each of the players to visually recognize an evaluation result at a glance. Note that, in the example illustrated in FIG. 20, the output control unit 14d performs its control such that, for example, the messages 811 to 813 and the visual effects 801 and 802 disappear in a short period of time and new visual effects are displayed at the timing a player beats time. Note that a graphic caused to be displayed in a visual effect by the output control unit 14d is not limited to the star shape, and a configuration may be such that the output control unit 14d causes an image around a player to be changed like a ripple instead of displaying a graphic. In addition, in FIG. 20, an example in which the output control unit 14d causes visual effects to be displayed around the players is illustrated. However, a configuration is not limited thereto, and a configuration may be such that visual effects are displayed around the evaluation results of the respective players or visual effects are displayed in random locations in a screen.

In addition, a configuration may be such that, instead of displaying new images according to evaluation results, the output control unit 14d performs its control such that images already displayed are replaced by other images according to evaluation results. For example, a configuration may be such that the output control unit 14d performs its control such that a star-shaped image flows in according to a tempo, and the output control unit 14d performs its control so as to change the star-shaped image to an image of a music note if an evaluation result of “Excellent!” is obtained, at a predetermined timing of a beat.

Note that a configuration may be such that, the output control unit 14d controls output of visual effects not only based on an evaluation result of a timings of one beat in the reference tempo, but also based on an evaluation result of timings of plural beats in the reference tempo. For example, the output control unit 14d may associate specific portions of a graphic with the respective evaluation result of timing of each of the four beats. For example, each time an “Excellent!” judgement is obtained at a timing of one beat, the output control unit 14d may causes a portion of the graphic, associated with the timing of the beat, to be displayed. According to such a configuration, the output control unit 14d may perform its control such that a specific graphic is completed when “Excellent!” judgements are obtained at all timings of beats.

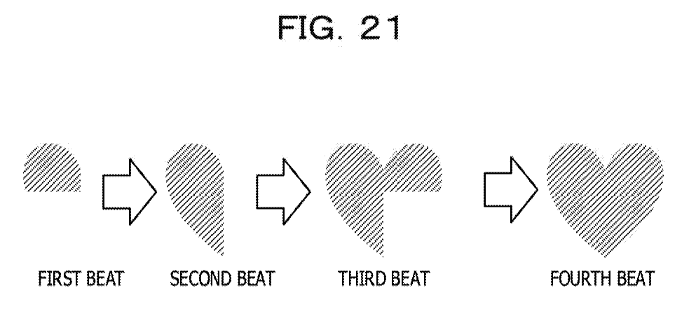

FIG. 21 is a diagram illustrating an example of a visual effect for displaying each part of a graphic according to the second embodiment. FIG. 21 illustrates an example in which, in a song of, for example, four-four time, portions of a heart-shaped graphic correspond to timings of four respective beats. When a player obtains an evaluation result of “Excellent!” at a timing of the first beat, the output control unit 14d causes the first portion to be displayed. In the same way, when, the player obtains respective evaluation results of “Excellent!” at each of the timing of the second beat, at the timing of the third beat, or at the timing of the fourth beat, the output control unit 14d causes portions corresponding to the respective timings to be displayed. According to such a configuration, the graphic is not completed unless the player beats time at all the timings of a set. Therefore, evaluation result of a dance is easier to be visually recognized, and a service with higher game property is provided.

Note that in a configuration in which the output control unit 14d outputs a portion of the graphic according to a result of keeping a rhythm, a configuration that assigns portions to respective players may be adopted. In a configuration outputting a graphic to be completed with, for example, three beats, the area control unit 14a performs its control so as to display the first portion of the graphic when the player A 401 keeps the first rhythm. In the same way, the area control unit 14a performs its control so as to display the second portion of the graphic when the player B 402 keeps the second rhythm, and the area control unit 14a performs its control so as to display the third portion of the graphic when the player C 403 keeps the third rhythm. According to such a configuration, players do not only compete each other, but another object of the game is presented to the players which is to complete a graphic by cooperation.

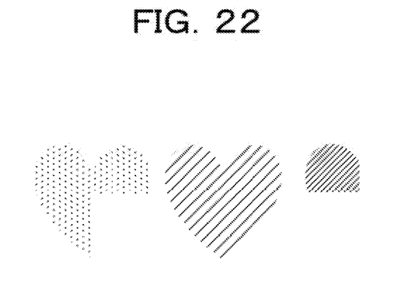

A configuration may be such that the output control unit 14d performs its control so that a displayed graphic gradually disappear at a timing at which, for example, 4 tempi finish and a portion of a next graphic is displayed on the side. FIG. 22 is a diagram illustrating another example of the visual effect for displaying each part of a graphic according to the second embodiment. The example illustrated in FIG. 22 illustrates an example of a visual effect output in a stage in which a rhythm is kept for 3 tempi out of 4 tempi at the first beat, a rhythm is kept for all the 4 tempi at the second beat, and a rhythm is kept for one tempo at the third beat. As illustrated in FIG. 22, the output control unit 14d controls output so that an ended beat becomes gradually pale in color and disappears as time passes. Note that a configuration may be such that the output control unit 14d controls output so that the graphic corresponding to the ended beat gradually scrolls and moves out of a screen instead of gradually disappearing.

Note that in each of the examples illustrated in FIG. 21 and FIG. 22, a configuration in which the output control unit 14d outputs each part of the heart-shaped graphic associated with evaluation results at respective point of time of evaluation. However, there is no limitation thereto. A configuration may be such that the output control unit 14d outputs portions of a person, such as, for example, eyes, a nose, mouth, and so forth, or a configuration in which the output control unit 14d outputs a paw, leg, tail, and so forth of an animal. In addition, in each of FIG. 21 and FIG. 22, an example in which beats serving as evaluation targets are four beats is illustrated, but there is no limitation thereto, and a configuration in which a graphic is completed with, for example, three beats or six beats may be adopted. In addition, a configuration may be such that, in place of portions of a graphic, one character is displayed every time an evaluation result of “Excellent!” is obtained for one beat, and a keyword is completed only when evaluation results are obtained for all beats serving as targets.

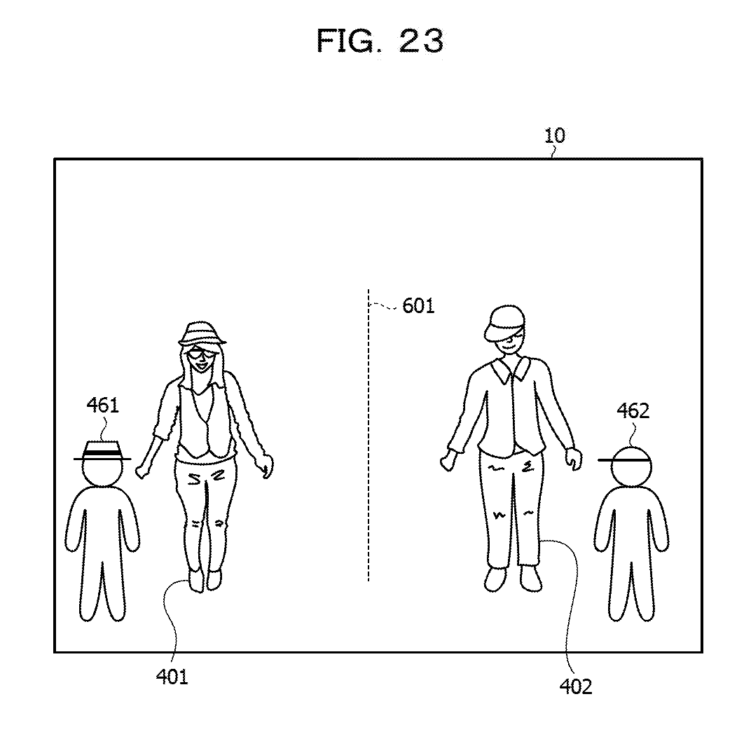

In addition, a configuration may be such that the output control unit 14d causes characters to be displayed on a screen and causes each of evaluation results of players to be visually displayed based on a motion of the corresponding character. FIG. 23 is a diagram illustrating an example of a visual effect for displaying characters according to the second embodiment. A character 461 in FIG. 23 dances to the motion of the player A 401. In a case in which, for example, the player A 401 keeps a large number of rhythms, the motion of the character 461 becomes active, and in contrast, when the player A 401 keeps few rhythms, the character 461 may falls down or a motion thereof stops. In the same way, a character 462 in FIG. 23 dances to a motion of the player B 402.

Since the characters move in tune with evaluation of the respective players in this way, it is easier for the player to visually recognize evaluation of the dance of the player.

Note that an effect in which the output control unit 14d controls output according to an evaluation is not limited to the visual effect. For example, a configuration may be such that the output control unit 14d performs its control so as to output, for example, sound for the reference tempo in tune with music and to output different sound when a dance of a player matches the reference tempo, thereby notifying the player of an evaluation. In addition, a configuration may be such that when a dance matches the reference tempo, the output control unit 14d uses an effect based on a tactile sensation, such as controlling to cause, for example, the corresponding one of wrist bands 451 to 453 worn by the players to be vibrated, thereby notifying the corresponding player of an evaluation. Furthermore, a configuration may be such that the output control unit 14d combines the information of the evaluation result, visual effect, effect based on sound, and the effect based on a tactile sensation so as to notify an evaluation result to a player. This thereby enables a player to recognize an evaluation even when it is difficult for a player who is dancing to visually recognize a screen.

As described above, the evaluation device is able to provide a service in which the player easily recognizes the evaluation result and provide service with high game property, by outputting visual effect, acoustic effect, tactile sensation effect or the combination thereof, according to an evaluation result of a player.

### Third Embodiment

If, in each of the above-mentioned embodiments, a player crosses a dividing line and enters an evaluation target area of another player, or players are too close to each other, it may become difficult to properly evaluate motions of respective players. Therefore, a configuration may be considered in which when a player moves and crosses a dividing line or is too close to another player, the evaluation device issues, to the player, a warning prompting to return to an original position.

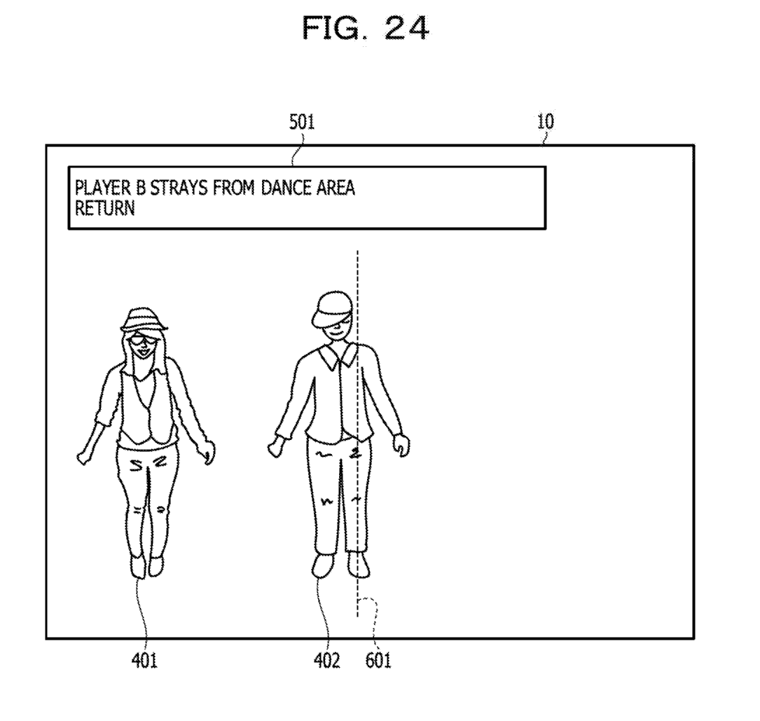

In the present embodiment, the area control unit 14a in the evaluation device 10 detects whether or not each of the players moves and crosses the indication partitioning respective evaluation target areas. When detecting that one of the players moves and crosses a partitioning indication, the area control unit 14a outputs, to the output control unit 14d, an instruction to cause a display to be displayed on a screen, the display notify that an evaluation target area has been trespassed. FIG. 24 is a diagram illustrating an example of a warning to a person who crossed a dividing line according to a third embodiment. In the example illustrated in FIG. 24, the player B 402 crosses the dividing line 601 and moves into the evaluation target area of the player A 401. If the area control unit 14a detects such a movement of the player B 402, the output control unit 14d performs its control so as to output a message for prompting to return to the player's own evaluation target area as illustrated in the message area 501.

In FIG. 24, a configuration of detecting that a player moves and crosses a dividing line is described, however, an embodiment is not limited thereto. For example, in cases in which the area control unit 14a determines the number of players using facial recognition technology or object recognition technology, a configuration may be such that players too close to each other are detected based on a facial recognition result or an object recognition result.

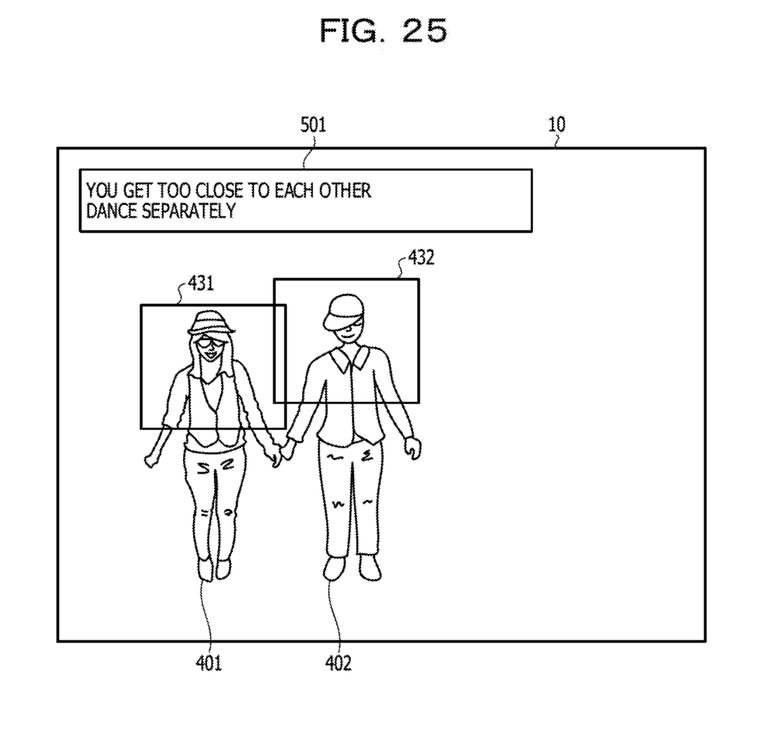

A description follows regarding a configuration of detecting that players are too close to each other with reference to FIG. 25. FIG. 25 is a diagram illustrating an example of a warning when players according to the third embodiment get too close to each other. In the example illustrated in FIG. 25, the area control unit 14a outputs, to the output control unit 14d, an instruction to output such a message as illustrated in the message area 501 in FIG. 25, when facial recognition areas for recognizing respective players overlap with each other. Note that, in detecting the degree of closeness between the player A 401 and the player B 402, facial recognition areas 431 and 432 are set to areas larger than the facial recognition areas 421 and 422. In addition, as a configuration in which the output control unit 14d issues a warning when the players get too close to each other, a configuration in which, as illustrated in FIG. 25, the output control unit 14d causes no dividing line for evaluation target areas to be displayed may be adopted.

Note that a configuration may be such that the area control unit 14a causes the output control unit 14d to output a visual effect in a form causing a player to more easily recognize a notice, such as changing the color of a screen, blinking the screen, or the like. In addition, a configuration may be such that, when a player moves and crosses a dividing line, the area control unit 14a outputs, to the evaluation unit 14c, an instruction to subtract points from an evaluation of the relevant player.

According to the present embodiment, it is possible to inhibit dances of respective players from being improperly evaluated because plural players enter one evaluation target area or players get too close to each other.

### Fourth Embodiment

In each of the above-mentioned embodiments, a configuration may be such that, in addition to individually evaluating motions of respective players, the evaluation device evaluates whether or not players beat time at the same timing, in other words, whether or not the motions of the respective players are synchronized with one another. A configuration in which the evaluation device assigns a high evaluation when the motions of, for example, all the respective players are synchronized with one another may be adopted. In the present embodiment, synchronization determination processing for identifying the degree of synchronization between motions of respective players will be described. In the present embodiment, the degree of synchronization between motions of respective players is expressed as a “synchronization rate” in some cases.

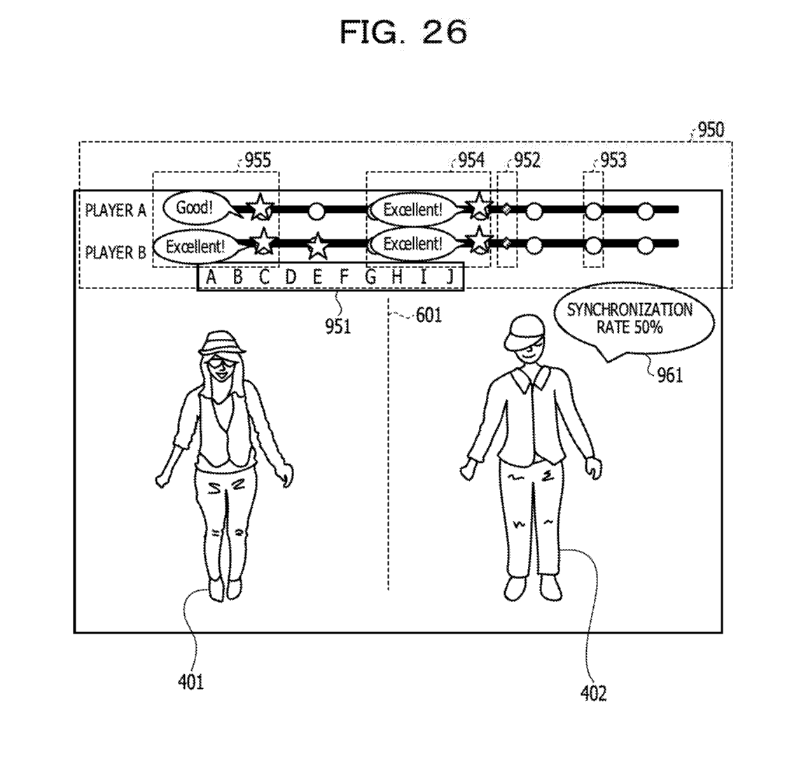

In the present embodiment, in addition to individually evaluating dances of respective players, the evaluation unit 14c evaluates whether or not players beat time at the same timing. FIG. 26 is a diagram illustrating an example of synchronization determination processing according to a fourth embodiment. In FIG. 26, evaluation results of respective players are displayed in an upper portion of a screen along with lyrics 951, as illustrated by a symbol 950. In FIG. 26, cursors 952 indicate points at which the players are singing, and points 953 indicate reference tempi at which the respective players beat time.

At points illustrated by a symbol 954 in FIG. 26, the players each obtain an evaluation result of “Excellent!”. In this case, the evaluation unit 14c evaluates that the dances of the respective players are synchronized with each other, and the evaluation unit 14c updates the synchronization rate. In addition, the evaluation unit 14c causes a display of the synchronization rate to be output, the display of the synchronization rate being illustrated by, for example, a symbol 961 in FIG. 26. As illustrated by the symbol 961 in FIG. 26, the display of the synchronization rate includes information in which, for example, a notation such as “synchronization rate” is combined with a numerical value such as “50%”, as information in which the synchronization rate is associated with a numerical value. In contrast thereto, at points indicated by a symbol 955 in FIG. 26, timings at which the respective players beat time do not match each other. Therefore, the evaluation unit 14c updates no synchronization rate.

According to the present embodiment, in addition to a competition between the players, an element that the players cooperate with each other is added. Therefore, it is possible to enhance the game property and to facilitate dances with a feeling of uniformity. Note that a configuration may be such that even if tempi are able to be acquired from persons at the same timing, if the relevant timing is different from a correct timing, for example, when evaluation results of “Excellent!” are not obtained, no score is added.

### Fifth Embodiment

Embodiments related to the disclosed device are described as above. However, the present technology may be implemented in various different forms in other than the above-mentioned embodiments.

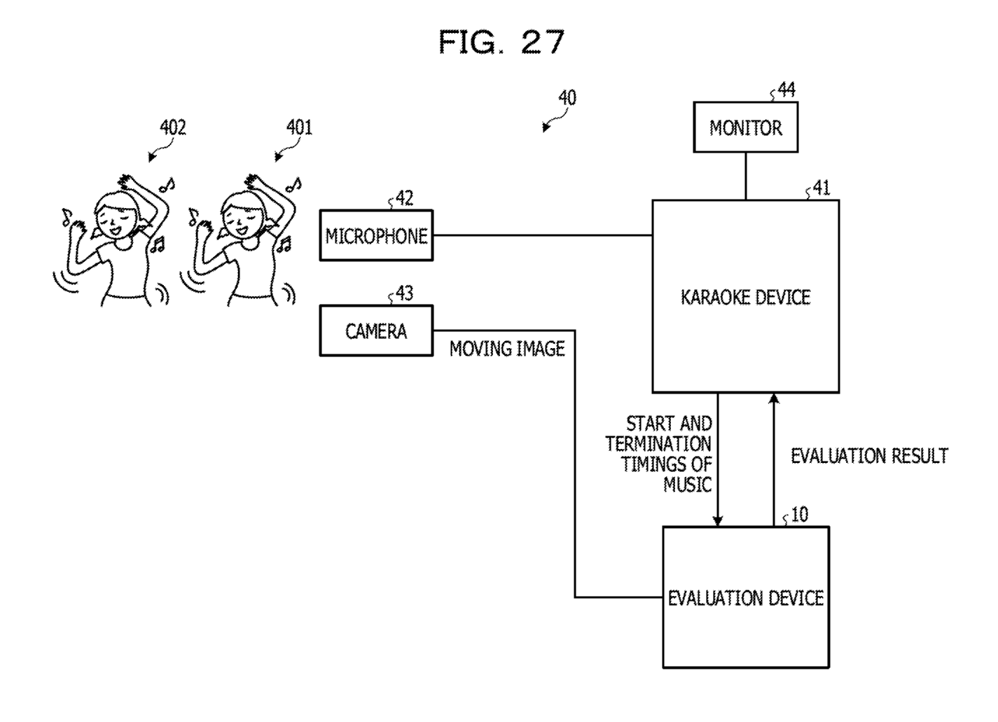

For example, as described above, the evaluation device 10 (hereinafter, simply referred to as an evaluation device in some cases) may extract a rhythm of a player in synchronization with a karaoke device provided in a karaoke box. For example, the evaluation device 10 may extract a rhythm of a player in real time in synchronization with the karaoke device. Here, the term “real time” includes, for example, a form of serially performing processing on input frames and sequentially outputting processing results. FIG. 27 is a diagram illustrating an example of a system in cases in which an evaluation device and a karaoke device operate in synchronization with each other. A system 40 illustrated in the example of FIG. 27 includes a karaoke device 41, a microphone 42, a camera 43, a monitor 44, and the evaluation device 10. For the player A 401 and the player B 402 who perform karaoke, the karaoke device 41 reproduces a song specified by the player A 401 or the player B 402 and outputs the song from a speaker, not illustrated. The player A 401 and the player B 402 are thus able to sing the reproduced song by using the microphone 42 and to dance to the song. In addition, at a timing to start reproduction of the song, the karaoke device 41 notifies the evaluation device of a message indicating that it is a timing to start the reproduction of the song. In addition, at a timing to end reproduction of the song, the karaoke device 41 notifies the evaluation device of a message indicating that it is a timing to end the reproduction of the song.

Upon receiving the message indicating that it is a timing to start the reproduction of the song, the evaluation device transmits, to the camera 43, an instruction to start image-capturing. Upon receiving the instruction to start image-capturing, the camera 43 starts image-capturing the player A 401 and the player B 402 who are present in an imaging area, and the camera 43 sequentially transmits, to the evaluation device, frames of the moving image data 13a obtained by the image-capturing.

In addition, sound information including voices of the players who are singing a song and who are dancing to the reproduced song and the reproduced song, the sound information being collected by the microphone 42, is sequentially transmitted to the evaluation device via the karaoke device 41. Note that such sound information is output in parallel with the frames of the moving image data 13a.

Upon receiving the frames transmitted by the camera 43, the evaluation device performs the above-mentioned various kinds of processing on the received frames. In addition, the evaluation device extracts timings at which the respective player A 401 and player B 402 beat time, and the evaluation device registers various kinds of information in the timing data 13b. In addition, upon receiving the sound information from the karaoke device 41, the evaluation device acquires the reference tempo from the received sound information. In addition, the evaluation device performs the above-mentioned evaluation and transmits an evaluation result to the karaoke device 41.

Upon receiving the evaluation result, the karaoke device 41 causes the received evaluation result to be displayed on the monitor 44. Thus, the player A 401 and the player B 402 are able to recognize the evaluation result. Note that the evaluation device 10 is able to cause the evaluation result to be displayed on the monitor 44 in real time. Therefore, according to the system 40, it is possible to swiftly output the evaluation result.

In addition, upon being notified by the karaoke device 41 of the message indicating that it is a timing to end the reproduction of the song, the evaluation device transmits, to the camera 43, an instruction to stop image-capturing. Upon receiving the instruction to stop image-capturing, the camera 43 stops the image-capturing.

As described above, in the system 40, the evaluation device is able to output the evaluation result in synchronization with the karaoke device 41 provided in the karaoke box.

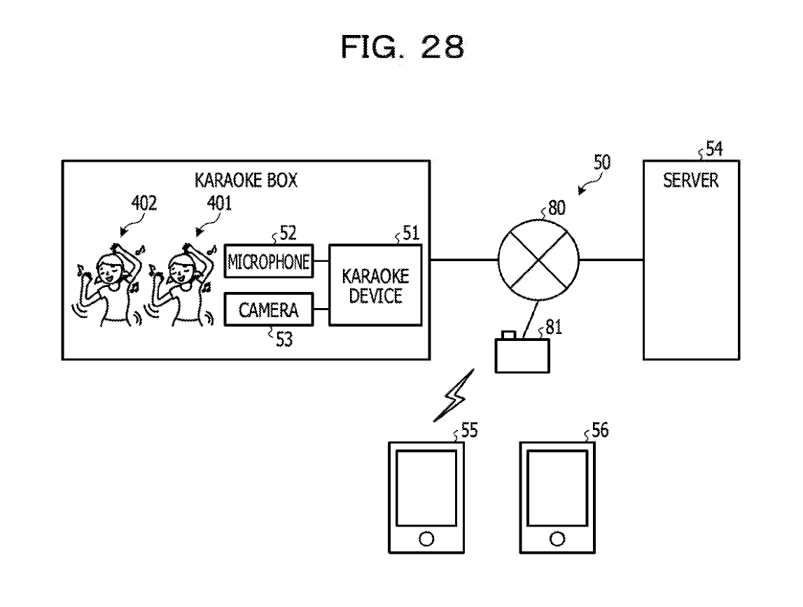

In addition, a server provided outside of the karaoke box may have the same functions as the various kinds of functions included in the evaluation device, and the server may output an evaluation result. FIG. 28 is a diagram illustrating an example of a system including a server. A system 50 illustrated in the example of FIG. 28 includes a karaoke device 51, a microphone 52, a camera 53, a server 54, and mobile terminals 55 and 56. For the player A 401 and the player B 402 who perform karaoke, the karaoke device 51 reproduces a song specified by the player A 401 or the player B 402 and outputs the song from a speaker, not illustrated. Thus, the player A 401 and the player B 402 are able to sing the reproduced song by using the microphone 52 and to dance to the song. In addition, at the time to start reproduction of the song, the karaoke device 51 transmits, to the camera 53, an instruction to start image-capturing. In addition, at a timing to end the reproduction of the song, the karaoke device 51 transmits, to the camera 53, an instruction to stop the image-capturing.

Upon receiving the instruction to start image-capturing, the camera 53 starts image-capturing the player A 401 and the player B 402 who are present in an imaging area, and the camera 53 sequentially transmits, to the karaoke device 51, frames of the moving image data 13a obtained by the image-capturing. Upon receiving the frames transmitted by the camera 53, the karaoke device 51 sequentially transmits the received frames to the server 54 via a network 80. In addition, the karaoke device 51 sequentially transmits, to server 54 via the network 80, sound information including voices of the players who are singing a song and who are dancing to the reproduced song and the reproduced song, the sound information being collected by the microphone 52. Note that such sound information is output in parallel with the frames of the moving image data 13a.

The server 54 performs, on the frames transmitted by the karaoke device 51, the same processing as the above-mentioned various kinds of processing performed by the evaluation device. In addition, the server 54 extracts timings at which the respective player A 401 and player B 402 beat time, and the server 54 registers various kinds of information in the timing data 13b. In addition, upon receiving the sound information from the karaoke device 41, the evaluation device acquires the reference tempo from the received sound information. Then, the evaluation device performs the above-mentioned evaluation and transmits an evaluation result to the mobile terminal 55 held by the player A 401 and the mobile terminal 56 held by the player B 402, via the network 80 and a base station 81.

Upon receiving the evaluation result, the mobile terminals 55 and 56 cause the received evaluation result to be displayed on displays in the respective mobile terminals 55 and 56. Thus, the player A 401 and the player B 402 are able to recognize the evaluation result from the mobile terminal 55 held by the player A 401 and the mobile terminal 56 held by the player B 402, respectively.

In addition, according to various kinds of loads, various usage situations, and so forth, processing operations at respective steps in individual processing operations described in the embodiments may be subdivided or integrated as desired. Furthermore, a step may be omitted.

In addition, according to various kinds of loads, various usage situations, and so forth, the order of processing operations at individual steps in each of processing operations described in the embodiments may be changed.

In addition, each of configuration components in each of devices illustrated in drawings is functional and conceptual and does not have to be physically configured in such a way as illustrated in the drawings. Namely, specific states of the distribution or integration of the individual devices are not limited to these illustrated in the drawings, and all or part of the individual devices may be functionally or physically integrated or distributed in any given units according to various kinds of loads and various usage situations. The camera 43 described in the embodiment may be connected to, for example, the karaoke device 41 so as to be communicable with the evaluation device via the karaoke device 41. In addition, the functions of the karaoke device 41 and the evaluation device described in the embodiments may be implemented by, for example, a single computer.

Note that separation between areas and a display for dividing areas may be fixed forms or may be fluctuating (moving) forms. A configuration may be such that, according to evaluation of players, a partitioning display moves so that the area of a player whose score is high becomes wide, for example. From this, it is possible to provide a service with high game property.

In addition, in the third embodiment, a configuration in which issuing of a warning when a player enters an evaluation target area of another player is described. However, a configuration may be such that, in contrast, the area control unit 14a issues, for example, an instruction to prompt a player to move into another evaluation target area. If a configuration is adopted in which the area control unit 14a adds a score when a player moves into another evaluation target area within a specified time period, it is possible to handle a dance with high game property and which is active. Note that since, in a case of detecting a motion of a player who is moving across areas, a processing load becomes high or false recognition occurs in some cases, a configuration may be adopted in which no detection of motion is made during a specified time period and detection of positions of respective players is made at the time when the specified time period ends.

Evaluation Program

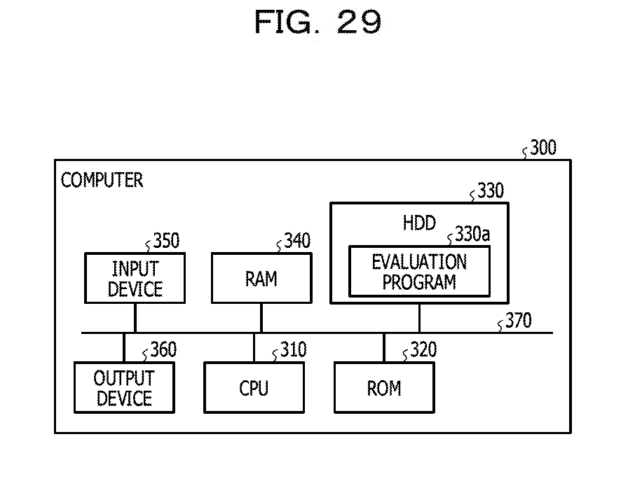

A computer program prepared in advance is executed by a computer system such as a personal computer or a workstation, thereby enabling various kinds of processing performed by the evaluation device 10 described in each of the above-mentioned embodiments. Therefore, an explanation follows, with reference to FIG. 29, regarding an example of a computer to execute an evaluation program having the same functions as those of the evaluation device described in any one of the first to fourth embodiments. FIG. 29 is a diagram illustrating a computer to execute an evaluation program.

As illustrated in FIG. 29, a computer 300 includes a CPU 310, a read only memory (ROM) 320, a hard disk drive (HDD) 330, a random access memory (RAM) 340, an input device 350, and an output device 360. These individual devices 310 to 360 are connected via a bus 370.

In the ROM 320, a basic program such as an operating system (OS) is stored. In addition, in the HDD 330, an evaluation program 330a to exert the same functions as those of the area control unit 14a, the acquisition unit 14b, the evaluation unit 14c, and the output control unit 14d illustrated in the above-mentioned embodiments is preliminarily stored. In addition, in the HDD 330, the moving image data 13a, the timing data 13b, the music tempo data 13c, and the evaluation data 13d are preliminarily stored.

The CPU 310 reads and executes the evaluation program 330a from the HDD 330. The CPU 310 reads and stores the moving image data 13a, the timing data 13b, the music tempo data 13c, and the evaluation data 13d from the HDD 330 and in the RAM 340. Furthermore, the CPU 310 uses various kinds of data stored in the RAM 340, thereby executing the evaluation program 330a. Note that regarding data stored in the RAM 340, all the data do not have to be stored in the RAM 340. Data to be used for processing only has to be stored in the RAM 340.

Note that the above-mentioned evaluation program 330a does not have to be stored in the HDD 330 from the start. The evaluation program 330a may be stored in a “portable physical medium” to be inserted into the computer 300, such as, for example, a flexible disk (FD), a CD-ROM, a DVD disk, a magneto-optical disk, or an IC card. Then, the computer 300 may read and execute the evaluation program 330a from one of these.

Furthermore, the evaluation program 330a may be stored in advance in “another computer (or a server)” or the like connected to the computer 300 via a public line, the Internet, a LAN, a WAN, or the like. In addition, the computer 300 may read and execute the evaluation program 330a from one of these.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing an evaluation program that causes a computer to execute a process, the process comprising:
obtaining a captured image captured by an imaging device;
displaying the plurality captured images on a display device and displaying a display that indicates a separation between a plurality of set areas set in the captured image while superimposing on the captured image; and
detecting timings at which each of a plurality of persons beat rhythm by analyzing the captured images, each of the plurality of persons being included in each of the plurality of set areas.

2. The non-transitory computer-readable storage medium according to claim 1, wherein the process further comprises:
evaluating the timings based on a result of the analyzing; and
outputting information indicating a result of the evaluating or at least one of a visual effect, an acoustic effect, and a tactile sensation effect that each indicate the result of the evaluating.

3. The non-transitory computer-readable storage medium according to claim 2, wherein the process comprises:
obtaining a plurality of captured images captured by the imaging device in specified period; wherein
a plurality of evaluation timings are set in the specified period; and wherein
the outputting includes outputting one of a plurality of portions included in a specified graphic when a specified evaluation result is obtained at one of the plurality of evaluation timings.

4. The non-transitory computer-readable storage medium according to claim 2, wherein the process comprises:
outputting, in the outputting, the information or the visual effect at at least one of a position corresponding to a position of a face of a person, a position located around the position of the face, and a position whose vertical coordinate in the captured image or lateral coordinate in the captured image corresponds to the position of the face of the person.

5. The non-transitory computer-readable storage medium according to claim 1, wherein
the plurality of set areas are set based on information related to the preliminarily entered number of persons or a result of recognition performed on a part of a person or an object possessed by a person, included in the captured image.

6. The non-transitory computer-readable storage medium according to claim 1, wherein
the plurality of set areas are two or three set areas.

7. The non-transitory computer-readable storage medium according to claim 1, wherein the process further comprises:
obtaining a plurality of captured images captured by the imaging device in specified period; and
wherein each of positions of the plurality of set areas set in each of the plurality of captured images is static in the specified period.

8. The non-transitory computer-readable storage medium according to claim 1, wherein the process comprises:
outputting a notification when a distance between the plurality of persons are less than a predetermined distance or at least one of the plurality of persons reaches a boundary between the plurality of set areas.

9. The non-transitory computer-readable storage medium according to claim 2, wherein
evaluating, in the evaluating, the timings based on a degree of coincidence between the motions of the plurality of persons.

10. An evaluation method executed by a computer, the evaluation method comprising:
obtaining a captured image captured by an imaging device;
displaying the plurality captured images on a display device and displaying a display that indicates a separation between a plurality of set areas set in the captured image while superimposing on the captured image; and
detecting timings at which each of a plurality of persons beat rhythm by analyzing the captured images, each of the plurality of persons being included in each of the plurality of set areas.

11. An evaluation device comprising:
a memory; and
a processor coupled to the memory and the processor configures to:
obtain a captured image captured by an imaging device;
display the plurality captured images on a display device and display a display that indicates a separation between a plurality of set areas set in the captured image while superimposing on the captured image; and
detect timings at which each of a plurality of persons beat rhythm by analyzing the captured images, each of the plurality of persons being included in each of the plurality of set areas.
